(19) United States
(12) Patent Application Publication
(10) Pub. No.: US 2010/0020668 A1
(43) Pub. Date: Jan. 28, 2010

(54) RECORDABLE OPTICAL RECORDING MEDIUM AND RECORDING METHOD THEREOF

(75) Inventors: Shinya Narumi, Kanagawa (JP); Katsuyuki Yamada, Kanagawa (JP); Noboru Sasa, Kanagawa (JP); Yoshitaka Hayashi, Kanagawa (JP); Toshishige Fujii, Kanagawa (JP); Masayuki Fujiwara, Kanagawa (JP); Masaki Kato, Tokyo (JP); Takeshi Kibe, Kanagawa (JP); Takuya Kohda, Kanagawa (JP); Hiroshi Miura, Miyagi (JP)

Correspondence Address: COOPER & DUNHAM, LLP, 30 Rockefeller Plaza, 20th Floor, NEW YORK, NY, 10112, US

(73) Assignee: Ricoh Company Ltd, Tokyo (JP)

(21) Appl. No.: 12/375,048

(22) PCT Filed: Jul. 27, 2007
(86) PCT No.: PCT/JP2007/065209

§ 371 Date: Jan. 26, 2009

(30) Foreign Application Priority Data
Aug. 1, 2006 (JP) 2006 210124
Aug. 2, 2006 (JP) 2006 210725
Sep. 4, 2006 (JP) 2006 239014
Jun. 15, 2007 (JP) 2007 159059
Jul. 2, 2007 (JP) 2007 173720

(51) Int. Cl. G11B 7/00; G11B 7/24

(52) U.S. Cl. 369/100; 369/275.4; G9B/7; G9B/7.139

(57) ABSTRACT

Provided is a recordable optical recording medium that comprises a substrate, a recording layer, and a reflective layer, wherein the recording layer and the reflective layer are formed on the substrate, the recording layer is formed of an inorganic material, and information is recorded on the recordable optical recording medium by use of an irreversible change at the recording layer caused by irradiating blue laser light.

### TECHNICAL FIELD

The present invention relates to recordable optical recording media, in particular optical recording media capable of high-density recording at a wavelength region of blue laser, and methods for recording on the optical recording media.

### BACKGROUND ART

In accordance with specification of digital versatile discs (DVD) that have been gaining popularity remarkably in recent years, such definitions are found as 650 nm of laser wavelength (λ) (635 nm in case of commercial recordable authoring), 0.6 of numerical aperture (NA) of objective lens, 0.6 mm of thickness of one substrate on which a recording layer is formed, and 4.7 GB of memory capacity per recording layer. The recording capacity can regenerate images, voices and subtitles for as long as 133 minutes which being sufficient to fully accommodate one of almost any movies.

On the other hand, developments have been carried out aiming to regenerate or record and regenerate high definition (HD) dynamic images for 2 hours; the necessary memory capacity is estimated to be about 15 GB; and HD DVD specification defines 405 nm of laser wavelength (λ), 0.65 of numerical aperture (NA) of objective lens, 0.6 mm of thickness of one substrate on which a recording layer is formed, and 15 GB of memory capacity per recording layer (HD DVD-R).

The HD DVD-R specification employs a signal treating technology (PRML) capable of increasing density of recording marks in addition to making high density by way of shortening wavelength of laser sources.

The PRML can provide a reading process durable against sign interference that tends to occur when the length of recording marks comes to shorter than the diameter of focused beams. Conventionally, when signals are regenerated from DVD recording media, a level slice process is employed in which a threshold voltage and a reading voltage are compared; however, when a PRML process that combines a partial response (PR) process and a maximum likelihood (ML) process is employed, the regeneration can be carried out more stably than the level slice process even in cases that the recording density being higher.

On the other hand, Blu-ray specification has been defined that attains the memory capacity of 25 GB/side, which being 4 times or more than that of DVD, by way that the recording-regenerating wavelength is shorted to about 405 nm, aperture number of objective lens is increased to about 0.85, and a disc structure of cover layer of 0.1 mm is employed, in order to realize high density.

In order to provide recordable optical recording media to record and regenerate using a laser light at a wavelength region of blue laser (i.e. recordable optical recording media HD DVD-R in HD DVD specification, and recordable optical recording media BD-R in Blu-ray specification), recording material other than CD-R and DVD±R has been developed.

The laser light at a wavelength region of blue laser indicates one having a wavelength of 405 nm±15 nm, i.e. between 390 nm to 420 nm. The wavelength of laser light defined in actual specification is 405 nm±15 nm, which is within this range in terms of both of Blu-ray disc specification and HD DVD specification.

In conventional recordable optical recording media, a laser light is irradiated onto a recording layer of an organic material, and recording pits are formed by making a change of refractive index mainly on the basis of decomposition and/or alternation of the organic material; thus the optical constant, the decomposing behavior, etc. of the organic material of the recording layer are important factors.

Therefore, the organic material used for recording layers of recordable optical recording media adapted to blue laser should be selected from those having optical properties and decomposing behaviors appropriate for the wavelength of blue laser.

That is, in a case of recordable optical recording media of high to low type (reflectance decreases upon recording), the recording-regenerating wavelength is selected at the hem of longer-wavelength side of a large absorption band in order to increase the reflectance at unrecorded stage and to cause a large change in the refractive index and to obtain a large modulation amplitude due to decomposition of the organic material upon irradiating the laser light. The reason is that the hem of longer-wavelength side of a large absorption band of the organic material is a wavelength region where the absorption coefficient is appropriate and a large refractive index is obtainable.

However, such a material has not been found yet that exhibits similar optical properties with respect to the wavelength of blue laser as those of conventional CD-R or DVD±R. The reason is that it is necessary to decrease molecular skeleton or to shorten conjugated system in order to set the absorption band of the organic material at the site near the wavelength of blue laser, which leading to decrease of the absorption coefficient, i.e. decrease of the refractive index.

That is, it is difficult for the high to low type to achieve very excellent recording-regenerating properties such as CD-R or DVD±R since organic materials typically do not have a large refractive index although there exist many organic materials having an absorption band near the wavelength of blue laser and the absorption coefficient can be controlled.

Hence there appears a tendency in recent years that the recording polarity is made into “low to high”, so-called “reflectance at unrecorded portions being lower than that at recording mark portions”, in order to utilize organic material into recordable optical recording media adapted to blue laser.

However, from the standpoint of recording apparatuses, it cannot be denied that the recording polarity is preferably “high to low” in view of compatibility with read-only optical recording media (ROM) or conventionally used optical recording media.

The present inventors hence have proposed that an inorganic material is used as the recording layer instead of organic material. For example, recordable optical recording media capable of high-density recording even with a wavelength shorter than that of blue laser can be seen in Patent Literatures 1 to 4 that are of this inventors and Japanese Patent Application Laid-Open Nos. 2005-064328 and 2005-071626 that are of this applicant.

In these Patent Literatures 1 to 4 and the prior applications described above, the availability of a recording layer is proposed where the recording layer contains as the main ingredient an oxide of metals or semimetals in particular bismuth oxide or the recording layer contains bismuth oxide and the main ingredient other than oxygen is bismuth.

Incidentally, Ag is often used in reflective layers of optical recording media since high reflectance is typically obtainable and the thermal conductivity is appropriate. However, Ag is problematic in stability and typically suffers from a problem of Ag sulfuration and the resulting degradation when a layer adjacent to the reflective layer contains sulfur.

For the countermeasure, Patent Literature 5 discloses a process in which an interfacial layer is disposed between a protective layer and a reflective layer. Patent Literature 6 also discloses a process to improve stability by way of adding an additive element thereby to form an Ag alloy.

However, the process of Patent Literature 5 has a problem that the increase of the layer number leads to increase of production steps, and the process of Patent Literature 6 to employ Ag alloys is likely to be insufficient to prevent degradation.

The Ag or Ag alloys can also be utilized as a reflective layer of the recordable optical recording media, which the present inventors had proposed, that has a recording layer containing bismuth as the main ingredient other than oxygen and contains bismuth oxide; however, there arises a problem that excessively high reflectance tends to degrade recording sensitivity.

For example, when HD DVD-R SL (single layer) is produced by use of the recording layer that contains bismuth as the main ingredient other than oxygen and contains bismuth oxide and the recording polarity is high to low, and when the film thickness is designed so as to obtain the best PRSNR (partial response to noise ratio) and error rate, the reflectance is about 25% at data sites (specification value: 14% to 28%), the reflectance is about 30% to 32% at system lead-in (specification value: 16% to 32%), and the recording sensitivity of 1× is 9.0 to 10.0 mW (specification value: 10 mW or less), thus at least the specification values can be satisfied; however, still higher sensitivity is desirable.

When BD-R SL (single layer) is produced similarly by use of the recording layer that contains bismuth as the main ingredient other than oxygen and contains bismuth oxide and the recording polarity is high to low, and when the film thickness is designed so as to obtain the best jitter and error rate, the reflectance is about 25% at data sites (specification value: 11% to 24%), and the recording sensitivity of 1× is about 6.0 mW (specification value: 6 mW or less), thus the specification values can be satisfied, at least; however, still higher sensitivity is desirable.

As such, the reason, why the reflectance comes to excessively high in the recordable optical recording media having a recording layer that contains bismuth as the main ingredient other than oxygen and contains bismuth oxide, is that the recording layer also has a relatively high transmittance even at a wavelength of blue laser.

It is possible of course to control the reflectance of recordable optical recording media and to improve the sensitivity by way of adjusting the film thickness of the recording layer that contains bismuth as the main ingredient other than oxygen and contains bismuth oxide or the film thickness of a layer adjacent to the recording layer; however, layer construction or control of film thickness only from the viewpoint of sensitivity tends to degrade recording properties such as PRSNR, jitter and error rate.

Hence the present inventors have applied an Al—Ti alloy (Ti: 0.5 atomic %) in place of Ag reflective layers in the prior art as the reflective layer for recordable optical recording media having the recording layer that contains bismuth as the main ingredient other than oxygen and contains bismuth oxide.

The reason, why the content of Ti is set to be 0.5 atomic %, is that the reflective layer is conventionally required for a higher reflectance and a higher thermal conductivity and it is substantially a common sense that the amount of additive elements is 1% by mass or less base on Al in order not to impair the reflectance and thermal conductivity of AL (in case of Ti as the additive element, 1% by mass based on Ai corresponds to 0.58 atomic %).

As a result that the Al—Ti alloy (Ti: 0.5 atomic %) is applied as the reflective layer for recordable optical recording media having the recording layer that contains bismuth as the main ingredient other than oxygen and contains bismuth oxide, for example, the reflectance as recordable optical recording media can be suppressed to 80% or less compared to Ag reflective layers, and HD DVD-R SL, which being applied the recording layer that contains bismuth as the main ingredient other than oxygen and contains bismuth oxide, can attain a recording sensitivity of about 8.0 mW, consequently, the recording sensitivity can be improved.

In addition, when a ZnS—SiO₂ layer is dispose between the recording layer that contains bismuth as the main ingredient other than oxygen and contains bismuth oxide and a Al—Ti alloy (Ti: 0.5 atomic %), defects due to sulfuration like Ag reflective layer materials are not observed and storage reliability can be improved.

In addition, various technologies have been proposed for recordable optical recording media. For example, an optical recording method has been proposed where an optical recording medium having an organic dye recording layer is recorded in multi-levels at multi-steps to take adequate signal quality (see Patent Literatures 7, 8).

However, in cases where organic dyes are applied to the recording layer, the application to recordable optical recording media adapted to blue laser is difficult in particular when the recording polarity is “high to low” due to insufficient optical properties such as reflectance and modulation amplitude in the wavelength region of blue laser.

In addition, a recording strategy is employed at forming recording marks, in which pulse shape etc. of emission power is designed based on rules or manners in relation to the pulse shape etc. of emission power, in order to reduce thermal distribution due to species of recording marks or spaces before and after. The recording strategy significantly affects the recording, thus the optimization of the recording strategy is important.

A recording method is proposed in which data is recorded in multi-levels by way of irradiating a laser beam onto a dye-containing recording layer while changing the irradiating period as multi-steps, in order to prevent degradation of signal quality at regenerating, for example (e.g. Patent Literatures 9 to 11).

However, the proposed recording strategy is adapted to dye-containing recording layers, thus it is difficult to form appropriate recording marks in a case of a recording layer, containing bismuth oxide as the main ingredient, which is suited to blue laser and the subject of the present invention.

Hence the present applicant has proposed previously a recordable optical recording medium that has at least a thin layer containing P and O elements and a thin layer of organic material on a substrate and a method for recording and regenerating thereof (e.g. Patent Literatures 2, 3). These optical recording media can undergo multivalued recording at wavelengths shorter than the wavelength region of blue laser. These technologies are also reported in non-Patent Literatures 1,2.

However, the recording strategy of the proposed recording and regenerating method may be insufficient for recording quality at forming recording marks, and still improvement is desired.

It is also an important element to assure stability of tracking servo at recording in order to record with appropriate recording quality, in addition to control record-mark forming processes by means of a recording strategy.

However, these technologies in the prior art tend to lead to a problem to deteriorate recording properties when stability of tracking servo is tried to enhance, regenerating stability of wobbled address information is tried to enhance, or regenerating stability of information recorded system lead-in regions by prepits is tried to enhance.

Patent Literature 1: Japanese Patent Application Laid-Open (JP-A) No. 2003-48375

Patent Literature 2: JP-A No. 2005-108396,

Patent Literature 3: JP-A No. 2005-161831,

Patent Literature 4: JP-A No. 2006-248177,

Patent Literature 5: JP-A No. 2004-327000,

Patent Literature 6: JP-A No. 2004-339585,

Patent Literature 7: JP-A No. 2001-184647,

Patent Literature 8: JP-A No. 2002-25114,

Patent Literature 9: JP-A No. 2003-151137,

Patent Literature 10: JP-A No. 2003-141725,

Patent Literature 11: JP-A No. 2003-132536,

non-Patent Literature 1: Write-Once Disk with BiFeO Thin Films for Multilevel Optical Recording, JJAP, vol. 43, No. 7B, 2004, p. 4972 non-Patent Literature 2: Write-Once Disk with BiFeO Thin Films for Multilevel Optical Recording, JJAP, vol. 44, No. 5B, 2005, pp. 3643-3644

### DISCLOSURE OF INVENTION

The present invention has been made in view of the prior art described above; it is an object of the present invention to provide a recordable optical recording medium that comprises an organic recording layer capable of forming recording marks with excellent accuracy even at a wavelength region of blue laser and capable of recording information with superior recording quality, in particular to improve recording properties and storage reliability still more with respect to recordable optical recording media that has a recording layer of an organic recording layer mainly containing bismuth oxide, and to provide a recording method suited to optical recording media in particular to those having a recording polarity of “high to low”.

The problems described above may be solved by the invention <1> to <22> described below.

<1> A recordable optical recording medium, comprising:

a substrate,

a recording layer, and

a reflective layer,

wherein the recording layer and the reflective layer are formed on the substrate,

the recording layer is formed of an inorganic material, and

information is recorded on the recordable optical recording medium by use of an irreversible change at the recording layer caused by irradiating blue laser light.

<2> The recordable optical recording medium according to <1>, wherein the wavelength of the blue laser light is 390 nm to 420 nm.
<3> The recordable optical recording medium according to <1> or <2>, wherein the substrate has a guide groove, and at least the recording layer, an upper protective layer, and the reflective layer are disposed in this order on the substrate.
<4> The recordable optical recording medium according to <1> or <2>, wherein the substrate has a guide groove, and at least a lower protective layer, the recording layer, an upper protective layer, and the reflective layer are disposed in this order on the substrate.
<5> The recordable optical recording medium according to <1> or <2>, wherein the substrate has a guide groove, and at least the reflective layer, an upper protective layer, the recording layer, and a cover layer are disposed in this order on the substrate.
<6> The recordable optical recording medium according to <1> or <2>, wherein the substrate has a guide groove, and at least the reflective layer, an upper protective layer, the recording layer, a lower protective layer, and a cover layer are disposed in this order on the substrate.
<7> The recordable optical recording medium according to <4> or <6>, wherein the lower protective layer is formed of an inorganic material mainly containing oxides, nitrides, carbides, sulfides, borides, silicides, elemental carbon, or mixtures thereof, and the layer thickness is 20 nm to 90 nm.
<8> The recordable optical recording medium according to any one of <3> to <7>, wherein at least one of the lower protective layer and the upper protective layer is formed of a material mainly containing ZnO—SiO₂.
<9> The recordable optical recording medium according to any one of <1> to <8>, wherein the substrate has a wobbled guide groove, the wobbled guide groove has a groove depth of 170 nm to 230 nm as the full width at half maximum and a groove depth of 23 nm to 33 nm.
<10> The recordable optical recording medium according to <9>, wherein the track pitch of the wobbled guide groove is within a range of 0.4±0.02 μm.
<11> The recordable optical recording medium according to <9> or <10>, wherein the amplitude of the wobble is within a range of 16±2 nm.
<12> The recordable optical recording medium according to any one of <1> to <11>, wherein the recording layer comprises bismuth as the main ingredient other than oxygen and further comprises bismuth oxide, and the reflective layer comprises at least one element selected from the element group (I), in an amount of 0.6 atomic % to 7.0 atomic % based on Al;

element group (I): Mg, Pd, Pt, Au, Zn, Ga, In, Sn, Sb, Be, Ru, Rh, Os, Ir, Cu, Ge, Y, La, Ce, Nd, Sm, Gd, Th, Dy, Ti, Zr, Hf, Si, Fe, Mn, Cr, V, Ni, Bi and Ag.

<13> The recordable optical recording medium according to <12>, wherein the amount of the at least one element selected from the element group (I) is 1.0 atomic % to 5.0 atomic %.
<14> The recordable optical recording medium according to any one of <1> to <13>, wherein the recording layer comprises bismuth, oxygen, and at least one element X selected from the element group (II);

element group (II): B, Si, P, Fe, Co, Ni, Cu, Ga, Ge, As, Se, Mo, Tc, Ru, Rh, Pd, Ag, Sn, Sb, Te, W, Re, Os, Ir, Pt, Au, Hg, Tl, Pb, Po, At, Zn, Cd and In.

<15> A recording method, for recording the recordable optical recording medium according to any one of <1> to <14>, wherein a recording mark is formed in accordance with a recording strategy that comprises a preheating step and subsequently a heating step,

a preheating pulse of preheating power (Pb), which being higher than regenerating power (Pr) and no higher than 70% of recording power (Pw), is irradiated in the preheating step, and

a recording pulse of the recording power (Pw) is irradiated at the heating step.

<16> A recording method, for recording the recordable optical recording medium according to any one of <1> to <14>,

wherein a recording mark is formed in accordance with a recording strategy that comprises a preheating step and subsequently a heating step and a cooling step,

a preheating pulse of preheating power (Pb), which being higher than regenerating power (Pr) and no higher than 70% of recording power (Pw), is irradiated in the preheating step,

a recording pulse of the recording power (Pw) is irradiated at the heating step, and

a cooling pulse of cooling power (Pc), which being lower than the preheating power (Pb), is irradiated at the cooling step.

<17> The recording method according to <15> or <16>, wherein the preheating pulse comprises two or more species of pulses having different power each other.
<18> The recording method according to any one of <15> to <17>, wherein the recording pulse is a monopulse.
<19> The recording method according to <18>, wherein the recording power of the monopulse is changed into two or more species depending on length of a recording mark to be formed.
<20> The recording method according to any one of <15> to <17>, wherein the recording pulse is a combination of two or more species of power.
<21> The recording method according to <16>, wherein the recording method further comprises, at the heating step, irradiating a laser light of power (Pm), which being lower than the recording power (Pw) and higher than the preheating power (Pb), to form a recording mark of 4T or larger (T: cycle of channel clock).
<22> The recording method according to <16>, wherein the cooling step is carried out subsequent to the heating step to form a recording mark of 2T (T: cycle of channel clock).

### BRIEF DESCRIPTION OF DRAWINGS

FIG. 1 is a schematic view that exemplarily shows a layer construction of a recordable optical recording medium according to the present invention.

FIG. 2 is a schematic view that exemplarily shows another layer construction of a recordable optical recording medium according to the present invention.

FIG. 3 is a schematic view that shows a preheating step and a following heating step at forming a recording mark in the inventive recording method.

FIG. 4 is a schematic view that shows a preheating step and a following heating step and a cooling step at forming a recording mark in the inventive recording method.

FIG. 5 is a schematic view that shows a preheating step and a following heating step and a cooling step at forming a recording mark in the inventive recording method.

FIG. 6 is a schematic view that shows a preheating step and a following heating step and a cooling step at forming a recording mark in the inventive recording method.

FIG. 7 is a schematic view that shows a preheating step and a following heating step and a cooling step at forming a recording mark in the inventive recording method.

FIG. 8 is a schematic view that shows a preheating step and a following heating step and a cooling step at forming a recording mark in the inventive recording method.

FIG. 9 is a schematic view that shows a preheating step and a following heating step and a cooling step at forming a recording mark in the inventive recording method.

FIG. 10 A is a schematic view that shows wave profiles of recording strategy in Examples 32 to 37 and Comparative Examples 8 to 11.

FIG. 10 B is a schematic view that shows parameters of recording strategy in Examples 32 to 37 and Comparative Examples 8 to 11.

FIG. 11A is a schematic view that shows wave profiles of recording strategy in Examples 38 to 48 and Comparative Examples 12 to 16.

FIG. 11B is a schematic view that shows parameters of recording strategy in Examples 38 to 48 and Comparative Examples 12 to 16.

FIG. 12 A is a schematic view that shows wave profiles of recording strategy in Examples 52 to 54 and Comparative Example 17.

FIG. 12 B is a schematic view that shows parameters of recording strategy in Examples 52 to 54 and Comparative Example 17.

FIG. 13 A is a schematic view that shows wave profiles of recording strategy in Examples 55 to 56 and Comparative Example 18.

FIG. 13 B is a schematic view that shows wave profiles of recording strategy in Examples 55 to 56 and Comparative Example 18.

FIG. 14 is a graph that shows a relation between a groove depth different in radius sites and a push pull in Examples 1 to 9.

FIG. 15 is a graph that shows a relation between a groove width at radius 40 mm and a push pull in Examples 1 to 9.

FIG. 16 is a graph that shows a relation between a groove depth at system lead in region and a modulation amplitude in Examples 1 to 9.

FIG. 17 is a graph that shows a relation between a groove depth at radius 40 mm and a PRSNR in Examples 1 to 9.

FIG. 18 is a graph that shows a relation between a groove depth at radius 40 mm and a SbER in Examples 1 to 9.

FIG. 19 is a graph that shows a relation between a thickness of a lower protective layer and a ratio of reflectance change in Example 11.

FIG. 20 is a graph that shows a relation between a thickness of a lower protective layer and a ratio of modulation-amplitude change in Example 11.

FIG. 21 is a graph that shows a relation between a thickness of a lower protective layer and a ratio of PRSNR change in Example 11.

FIG. 22 is a graph that shows a relation between a thickness of a lower protective layer and a ratio of SbER change in Example 11.

FIG. 23 is a graph that shows a relation between a reflectance or a PRSNR versus an amount of an element added to Al alloy.

FIG. 24 is graph that shows a relation between an initial PRSNR and a PRSNR after allowing to stand 300 hours at 80° C. and 85% RH.

### BEST MODE FOR CARRYING OUT THE INVENTION

The present invention will be explained in more detail as regards inventive embodiments, but to which the present invention should be in no way limited.

The inventive optical recording medium preferably has one of configurations described below, but to which the present invention should be in no way limited.

(a) substrate (light transmitting layer)/recording layer/upper protective layer/reflective layer,

(b) substrate (light transmitting layer)/lower protective layer/recording layer/upper protective layer/reflective layer,

(c) cover layer (light transmitting layer)/recording layer/upper protective layer/reflective layer/substrate,

(d) cover layer (light transmitting layer)/lower protective layer/recording layer/upper protective layer/reflective layer/substrate.

The still further multi-layer may be allowable based on the configurations described above; for example, the configuration described above may be doubled and the following layer configuration may be made based on the configuration (a).

(e) substrate (light transmitting layer)/recording layer/upper protective layer/reflective layer (semi-transmissive layer)/adhesive layer/recording layer/upper protective layer/reflective layer/substrate.

Optionally, an overcoat layer (environmentally resistant protective layer) may be disposed on the reflective layer, an intermediate layer (sometimes also referred to as interface layer, barrier layer, sulfuration preventive layer, or oxidation protective layer) may be disposed between the reflective layer, when being formed of Ag metal material, and the upper protective layer, a hard coat layer may be provided on the surface of the substrate or the cover layer (opposite side to contact with the recording layer or the lower protective layer), or a print layer may be provided on the overcoat layer, on the basis of these fundamental configurations. The mono-plate disc such as of (a) and (b) described above may be made into a structure laminated by an adhesive layer; in such a case, the adhesive layer may also act as the overcoat layer without thereof. The disc opposite to the laminating side may be only a transparent disc, a similar mono-plate disc, or a laminate having a reverse layer configuration with the mono-plate disc, that is, a mono-plate disc having a fundamental configuration of substrate/reflective layer/protective layer/recording layer/protective layer. A mono-plate disc may also be laminated without a print layer, and the print layer may be formed at the opposite side after laminating.

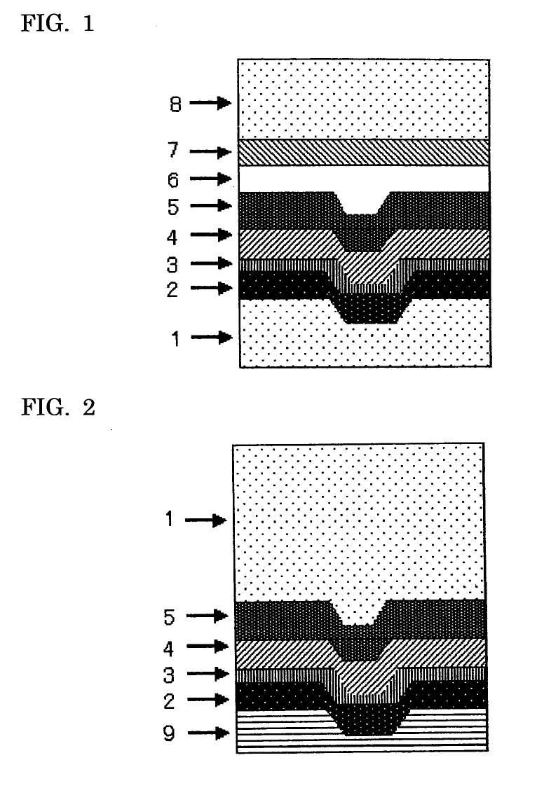

FIGS. 1, 2 are schematic views that show exemplarily layer configurations of inventive recordable optical recording media.

The recordable optical recording medium shown in FIG. 1 contains a lower protective layer 2, a recording layer 3, an upper protective layer 4, a reflective layer 5, an overcoat layer 6, an adhesive layer 7 and a protective substrate 8 disposed in order on a substrate 1.

The recordable optical recording medium shown in FIG. 2 contains a reflective layer 5, an upper protective layer 4, a recording layer 3, a lower protective layer 2 and a cover layer 9 in order on a substrate 1.

The constitutive layers will be explained in the following.

An inorganic material is employed for the inventive recording layer. Previously, recordable optical recording media having a recording layer formed of inorganic material have been proposed, as described in JP-A No. 2003-145934, and there exist ones that record information through making pits or pores into media by irradiating mainly laser light and ones that record information through changing structure by phase conversion or alloying and changing reflectance. However, it comes to difficult to form uniform pits along with increasing the recording density in the systems to form the pits, which possibly resulting in undesirable degradation of signal properties and recording sensitivity. On the other hand, there exists such a problem in the phase conversion systems that when a phase conversion is utilized between crystalline and noncrystalline, the recording marks may be erased, and there exists such a problem in the alloying systems that the reflectance alternation i.e. the contrast is little between recording marks and regenerating signals; comparing these systems, the systems to make use of structure change are desirable from the stand point of controlling the size of recording marks.

The material particularly preferable for the inventive recording layer is the inorganic recording material that contains bismuth as the main ingredient other than oxygen and contains bismuth oxide.

The bismuth may be contained in any conditions such as metal bismuth, bismuth alloys, bismuth oxide, bismuth sulfide, bismuth nitride and bismuth fluoride; bismuth oxide (one of oxides of bismuth) must be contained.

The bismuth oxide contained in the recording layer may lower the thermal conductivity, raise the sensitivity, reduce jitter, and lower imaginary part of complex refractive index of the recording layer, which can result in a recording layer with superior transparency and make easy to form the multilayer.

It is also preferred to improve the recording and regenerating properties that an element X other than bismuth is added to the recording layer. It is preferable in view of higher stability and thermal conductivity that bismuth and the element X are in an oxidized condition, but complete oxidization is unnecessary.

That is, when the inventive recording layer is formed from 3 elements of bismuth, oxygen and the element X, bismuth, bismuth oxide, the element X and an oxide of the element X may be included.

The processes to make exist the bismuth (metal bismuth) and bismuth oxide, i.e. the elemental bismuth being present under different conditions in the recording layer, are exemplified by (i) to (iii) as follows:

(i) process to sputter bismuth oxide as a target,

(ii) process to sputter a target of bismuth and a target of bismuth oxide (co-sputtering),

(iii) process to sputter a target of bismuth while introducing oxygen.

In the process (i), the tendency to defect oxygen is made use of under sputtering conditions such as vacuum degree and sputtering power, stating from the condition that the bismuth is completely oxidized as the target.

One of the reasons to add the element X to the recording layer is to reduce the thermal conductivity and to make easy to form fine marks. The thermal conductivity influences scattering of phonon and can be low when the size of particles or crystals comes to small, number of atoms constituting the material is large, or mass difference of atoms constituting the material is large.

Accordingly, when the element X is added to the recording layer that contains bismuth as the main ingredient other than oxygen and contains bismuth oxide, the thermal conductivity can be controlled and high-density recording capability can be enhanced.

In the recording layer that contains bismuth as the main ingredient other than oxygen and contains bismuth oxide, bismuth oxide or bismuth is crystallized upon recording, and the size of crystals or crystalline particles can be controlled by action of the element X.

Accordingly, the element X can control the size of crystals or crystalline particles at recording sites and thus recording-regenerating properties such as jitter can be significantly enhanced, which is another reason to add the element X to the recording layer.

From the viewpoint of the thermal conductivity, there exist substantially no conditions for the element X to be added to the recording layer, except for simple requirements such as stability of raw material and easiness of production. However, the following conditions (i) and (ii) are effective with respect to reliability, since the reliability of the recording layer such as stability at regenerating or storage may significantly be affected by the element X.

(i) the element has a Pauling electronegativity of 1.80 or more;

(ii) the element has a Pauling electronegativity of 1.65 or more, standard enthalpy change of formation ΔHf° of its oxide is −100 kJ/mol or more, and the element is other than transition metals.

The recordable optical recording medium can be attained with superior recording-regenerating properties like jitter and high reliability by use of an element X that satisfies the (i) or (ii).

The conditions (i), (ii) described above will be explained more specifically below.

The reason, why the reliability comes to low in terms of the recording layer that contains bismuth as the main ingredient other than oxygen and contains bismuth oxide, is mainly progressive oxidation or change of oxidation condition such as valency change.

The progressive oxidation or change of oxidation condition may possibly decrease the reliability, therefore, the Pauling electronegativity as well as the standard enthalpy change of formation ΔHf° of its oxide are important.

It is preferred firstly to select an element having a Pauling electronegativity of 1.80 or more as the element X in order to attain sufficient reliability.

This is because that oxidation tends to progress hardly in elements with higher Pauling electronegativity, and elements with a Pauling electronegativity of 1.80 or more is effective in order to attain sufficient reliability. The standard enthalpy change of formation ΔHf° of its oxide may be any value as long as Pauling electronegativity being 1.80 or more.

Examples of element X with a Pauling electronegativity of 1.80 or more include B, Si, P, Fe, Co, Ni, Cu, Ga, Ge, As, Se, Mo, Tc, Ru, Rh, Pd, Ag, Sn, Sb, Te, W, Re, Os, Ir, Pt, Au, Hg, Tl, Pb, Po and At.

The electronegativity will be explained briefly.

The electronegativity is a measure expressing a level at which an atom in molecules attract an electron. The value of the electronegativity may be of Pauling, Mulliken, or Allred-Rochow, etc.; the Pauling electronegativity is employed in this specification to determine adaptability of the element X.

The Pauling electronegativity is defined such that the subtract of an average of a binding energy E(AA) between atoms A-A and a binding energy E(BB) between atoms B-B from a binding energy E(AB) of A-B equals a square of the difference between electronegativities of atoms A, B, that is, as Equation (1) below.

E(AB)−[E(AA)+E(BB)]/2=96.48×(X_{A}−X_{B})² (1)

The conversion coefficient 96.48 corresponds to 1 eV=96.48 kJ/mol, since the value of Pauling electronegativity is calculated using a value of electron volt.

The actual value of electronegativity of an element depends on the atomic valence in molecules, therefore, the Pauling electronegativity is determined with the following limitations in this specification.

That is, each Pauling electronegativity corresponds to the atomic valence such as monovalence for 1st group elements, divalance for 2nd group elements, trivalance for 3rd group elements, divalence for 4th to 10th elements, monovalance for 11st group elements, divalance for 12th group elements, trivalence for 13th elements, tetravalence for 14th elements, trivalence for 15th elements, divalence for 16th elements, monovalence for 17th elements, and zerovalence for 18th elements.

The specific Pauling electronegativities of the element X with a Pauling electronegativity of 1.80 or more are B (2.04), Si (1.90), P (2.19), Fe (1.83), Co (1.88), Ni (1.91), Cu (1.90), Ga (1.81), Ge (2.01), As (2.18), Se (2.55), Mo (2.16), Tc (1.90), Ru (2.20), Rh (2.28), Pd (2.20), Ag (1.93), Sn (1.96), Sb (2.05), Te (2.10), W (2.36), Re (1.90), Os (2.20), Ir (2.20), Pt (2.28), Au (2.54), Hg (2.00), Ti (2.04), Pb (2.33), Po (2.00), and At (2.20).

Plural elements from these elements may be added to the recording layer that contains bismuth as the main ingredient other than oxygen and contains bismuth oxide.

When an element has a Pauling electronegativity of 1.65 or more, and standard enthalpy change of formation ΔHf° of its oxide is −1000 kJ/mol or more, sufficient reliability can be attained even when the Pauling electronegativity is below 1.80.

The reason, why this condition being effective, is believed that oxides are likely difficult to yield as long as the standard enthalpy change of formation ΔHf° of oxides is large even when the Pauling electronegativity is somewhat small.

When determining the Pauling electronegativity, the atomic valence is fixed depending on the elemental groups; standard enthalpy change of formation ΔHf° is determined under a similar condition as follows:

That is, each standard enthalpy change of formation ΔHf° of its oxide corresponds to the atomic valence such as monovalence for 1st group elements, divalance for 2nd group elements, trivalance for 3rd group elements, divalence for 4th to 10th elements, monovalance for 11st group elements, divalance for 12th group elements, trivalence for 13th elements, tetravalence for 14th elements, trivalence for 15th elements, divalence for 16th elements, and monovalence for 17th elements.

In this regard, transition metals form oxides with various atomic valences, therefore, standard enthalpy change of formation ΔHf° of oxide cannot be determined definitely, typically, the larger is the atomic valence of oxide, the smaller is the standard enthalpy change of formation ΔHf° of oxide. That is, transition metals are not the inventive preferable element X, since transition metals are believed to easily form oxides, and since the oxides can be formed with various atomic valences.

In a case of divalent vanadium (V), standard enthalpy change of formation ΔHf° of V oxide is −431 kJ/mol as for VO, which satisfies the condition (ii) of the inventive element X.

However, V forms easily oxides such as V₂O₃ (trivalence), V₂O₄ (tetravalence) and V₂O₅ (pentavalence), in addition to VO (divalence).

The standard enthalpy change of formation ΔHf° of these oxides are V₂O₃ (−1218 kJ/mol), V₂O₄ (−1424 kJ/mol) and V₂O₅ (−1550 kJ/mol) respectively, and these values are unsatisfactory for the condition (ii) of the inventive element X.

That is, provided that an oxide is formed from divalent V, the conditions (i) and (ii) described above are satisfied; however, V can easily form oxides other than divalent, and these oxides are easily oxidized more stably, thus V is excluded from the preferable element X.

The exclusion is clearly described by “the element is other than transition metals” in the condition (ii) as regards the inventive element X.

The standard enthalpy change of formation ΔHf° will be explained briefly.

In general, a chemical reaction is expressed by a chemical reaction formula, for example, as follows:

H₂(gas)+½O₂(gas)=H₂O(liquid)

Usually the left-hand side is referred to as “starting material” and the right-hand side is referred to as “generating material”. The coefficient in front of molecules is referred to as “stoichiometric number”. The heat generating or absorbing along with chemical reactions under a constant temperature is referred to as “reaction heat” and the reaction heat under a constant pressure is referred to as “constant-pressure reaction heat”. Reaction heat of usual experimental conditions is typically is measured under a constant pressure, therefore, the constant-pressure reaction heat is often used.

The constant-pressure reaction heat equals ΔH, i.e. the enthalpy difference between the starting material and the generating material. ΔH>0 corresponds to an endothermic reaction, and ΔH<0 corresponds to an exothermic reaction.

The reaction heat when a compound forms from constitutional elements is referred to as “formation heat” or “formation enthalpy”, and the reaction heat when a compound of one mole at standard condition is formed from constitutional elements at standard condition is referred to as “standard enthalpy change of formation”. The standard condition is selected as the most stable condition at pressure 0.1 MPa (about one atom) and a pre-determined temperature (usually 298 K), and the standard enthalpy change of formation is expressed by ΔHf°. The enthalpies of respective elemental substances are defined as zero at the standard condition.

Therefore, the smaller is the standard enthalpy change of formation as regards the oxide of certain element (negative and large absolute value), the more stable is the oxide and the element is easier to be oxidized.

Detail values of the standard enthalpy change of formation are described in “5th edition, edited by Electrochemical Society of Japan (Maruzen Co.)”, for example.

The actual value of standard enthalpy change of formation ΔHf° depends on the atomic valence, therefore, the standard enthalpy change of formation ΔHf° is determined with the limitations in this specification as described above.

The elements having a Pauling electronegativity of 1.65 or more and a standard enthalpy change of formation ΔHf° of its oxide of −1000 kJ/mol or more are exemplified by Zn, Cd, and In.

The Pauling electronegativity in accordance with the present invention is Zn (1.65), Cd (1.69) and In (1.78); and the standard enthalpy change of formation ΔHf° in accordance with the present invention is Zn (−348 kJ/mol), Cd (−258 kJ/mol) and In (−925 kJ/mol).

The ratio of total atom number of the element X to that of bismuth is preferably 1.25 or less. This is because that the ratio of above 1.25 in terms of total atom number of the element X to that of bismuth may make impossible to take inherent recording-regenerating properties, since the inventive recording layer essentially contains bismuth as the main ingredient other than oxygen and contains bismuth oxide.

It is preferred for the inventive recordable optical recording medium that the recording and regenerating is carried out by use of a laser light of 680 nm or less.

The inventive recording layer may represent an appropriate absorption coefficient and a high refractive index within a broad range in contrast to those of dyes, therefore, the recording and regenerating can be carried out by use of laser light having a wavelength of shorter than wavelength 680 nm or less of red laser, thus proper recording-regenerating properties and high reliability can be attained.

Most preferably in particular, the recording-regenerating is carried out by use of laser light of wavelength 450 nm or less. This is because that the recording layer, containing bismuth as the main ingredient other than oxygen and containing bismuth oxide, has a complex refractive index adapted to recordable optical recording media at a wavelength region of 450 nm or less in particular.

Specific examples of material of the recording layer include those of (i) to (v) described in Patent Literatures 2, 3 of the present applicant as described above. P (i) material formed of bismuth oxide,

(ii) material that contains elemental bismuth and bismuth oxide,

(iii) material comprising a bismuth oxide that contains Bi element and at least one element selected from 4B group, and has a composition of Biₐ4B_{b}O_{d} (4B: an element of 4B group; a, b and d are each an atom ratio), in which 10≦a≦40, 3≦b≦20, 50≦d≦70,

(iv) material comprising a bismuth oxide that contains at least one element selected from Al, Cr, Mn, In, Co, Fe, Cu, Ni, Zn and Ti, and has a composition of Biₐ4B_{b}M_{c}O_{d} (4B: an element of 4B group; a, b, c and d are each an atom ratio), in which 10≦a≦40, 3≦b≦20, 3≦c≦20, 50≦d≦70,

(v) material that mainly contains element Bi, element O, and also element X other than Bi, in which X is at least an element selected from B, Fe, Cu, Ti, Zn, etc.

The element of 4B group in (iii) and (iv) described above is exemplified by C, Si, Ge, Sn, Pb, etc., particularly preferable are Si and Ge.

The materials that mainly contain the bismuth oxide are particularly useful as a material of the recording layer suited to blue laser, and have features that the thermal conductivity is low, the durability is proper, and high reflectance and high transmittance are attainable due to the complex refractive index.

Furthermore, such advantages may be attainable by use of the materials that mainly contain the bismuth oxide.

(i) use of oxide may enhance film hardness (deformation may be prevented in terms of the thin film itself at the recording layer or adjacent layer such as substrates),

(ii) use of oxide may enhance the storage stability,

(iii) inclusion of an element such as Bi having a high light absorptance at a wavelength region of 500 nm may enhance the recording sensitivity,

(iv) inclusion of a low-melting point element or easily dispersible element such as Bi may form recording marks to generate a large modulation amplitude even without large deformation,

(v) vapor-phase growth process such as sputtering may form appropriate thin films.

The process to form the recording layer may be exemplified by sputtering processes, ion plating processes, chemical vapor deposition processes, vacuum vapor processes, etc., preferable are sputtering processes.

The composition of the recording layer may fluctuate indeed in the sputtering processes depending on the conditions of targets, sputtering ability of elements or compounds, electric power at forming film, flow rate of argon, etc. In addition, the composition of target and the composition of the resulting film are often different, and the difference may be taken into consideration.

The optimum thickness of the recording layer typically depends on the conditions of optical recording media in use; preferably, the thickness is 5 to 30 nm, more preferably 10 to 25 nm. The film thickness below 5 nm tends to lower the modulation amplitude of recording marks, and the film thickness above 30 nm may decrease the accuracy of recording marks, both resulting in undesirable properties of recording signals.

Incoming or outgoing of oxygen at the recording layer containing oxides may influence the properties; the incoming and outgoing of oxygen may be prevented by providing an upper protective layer and a lower protective layer at both sides of the recording layer, and the storage stability may be enhanced.

The preferable materials for the protective layer are typically those free from decomposition, sublimation, or hollowing due to heat from the recording layer upon recording; examples thereof include simple oxides such as Nb₂O₅, Sm₂O₃, Ce₂O₃, Al₂O₃, MgO, BeO, ZrO₂, UO₂ and ThO₂; silicate oxides such as SiO₂, 2MgO—SiO₂, MgO—SiO₂, CaO.SiO₂, .ZrO₂ SiO₂, 3Al₂O₃.2SiO₂, 2MgO.2Al₂O₃.5SiO₂, and Li₂O Al₂O₃.4SiO₂; complex oxides such as. A₂TiO₅, MgAl₂O₄, Ca₁₀(PO₄)₆(OH)₂, BaTiO₃, LiNbO₃, PZT[Pb(Zr,Ti)O₃], PLZT[(Pb,La)(Zr,Ti)O₃], and ferrites; nonoxide nitrides such as Si₃N₄, AlN, BN and TiN; nonoxide carbide such as SiC, B₄C, TiC and WC; nonoxide boride such as LaB₆, TiB₂ and ZrB₂; nonoxide sulfide such as ZnS, CdS and MoS₂; nonoxide silicide such as MoSi₂; and nonoxide carbon materials such as amorphous carbon, graphite and diamond.

Among them, the materials mainly containing SiO₂ or ZnS—SiO₂ are preferable in view of transparency to recording-regenerating light and productivity, the materials mainly containing ZrO₂ are preferable in view of sufficient insulating effect, and the materials mainly containing Si₃N₄, AlN or Al₂O₃ are preferable in view of stability. The term “mainly containing” means that the content is about 90% or more.

ZnS—SiO₂ in particular can prevent effectively the incoming and outgoing of oxygen or moisture, thus are appropriate to enhance storage stability. The film of ZnS—SiO₂ can be formed by DC sputtering by way of adding carbon or transparent conductive materials and affording a conductivity. In addition, the temperature of the recording layer can be raised effectively to the level at which recording marks are formed, thus the recording sensitivity can be remarkably increased, i.e. the recording can be carried out at lower recording power. In order to adjust the thermal conductivity, ZnO, GeO, etc. may be added, or oxides and nitrides may be mixed. The mixing ratio of ZnS:SiO₂ is preferably 70:30 to 90:10 by mole %, particularly preferably 80:20 where the resulting film stress being approximately zero.

The process to form the inorganic protective layer may be exemplified by sputtering processes, ion plating processes, chemical vapor deposition processes, vacuum vapor processes, etc., similarly as those of the recording layer described above.

The protective layer may be formed of an organic material such as dyes and resins. Examples of the dyes include polymethine, naphthalocyanine, phthalocyanine, squarylium, chloconium, pyrylium, naphthoquinone, anthraquinone (indanethrene), xanthene, triphenylmethane, azulene, tetrahydrocoline, phenanthrene, triphenothiazine, azo, formazan dyes, and metal complex compounds thereof.

Examples of the resins include polyvinyl alcohol, polyvinyl pyrrolidone, nitrocellulose, cellulose acetate, ketone resins, acrylic resins, polystyrene resins, urethane resins, polyvinyl butyral, polycarbonate, and polyolefin; these may be used alone or in combination.

The protective layer made of organic material may be formed by conventional processes such as vapor deposition, sputtering, CVD and solvent-coating processes. The coating process may be carried out by dissolving the organic material described above into an organic solvent and coating by conventional processes of spray, roller, dipping, or spin coating.

Examples of the organic solvent include alcohols such as methanol, ethanol and isopropanol; ketones such as acetone, methylethylketone and cyclohexanone; amides such as N,N-dimethylacetamide and N,N-dimethylformamide; sulfoxides such as dimethylsulfoxide; ethers such as tetrahydrofuran, dioxane, diethylether and ethyleneglycol monomethylether; esters such as methylacetate and ethylacetate; aliphatic halogenated hydrocarbons such as chloroform, methylene chloride, dichloroethane, carbon tetrachloride and trichloroethane; aromatics such as benzene, xylene, monochlorobenzene and dichlorobenzene; cellosolves such as methoxyethanol and ethoxyethanol; and hydrocarbons such as hexane, pentane, cyclohexane and methylcyclohexane.

The film thicknesses of the upper protective layer and the lower protective layer may be properly designed considering the recording sensitivity, recording-regenerating signals such as reflectance, and mechanical properties; in cases where the recording layer should perform to protect the recording layer, the film thickness is required to be at least 5 nm, preferably 10 nm or more. On the other hand, excessively large film thickness may be undesirable for layers of inorganic material in particular, since thermal deformation occurs at forming the protective layer and the film bends due to shrinkage, thus mechanical properties may not be assured.

When a substrate of a resin material exists on the downside of the lower protective layer, the thickness of the lower protective layer is preferably thicker, i.e. 20 nm or more.

As such, the thickness of the lower protective layer is preferably 5 to 150 nm, more preferably 20 to 90 nm. When ZnS—SiO₂ (80:20 by mole %) is used, the thickness is preferably 30 to 90 nm.

In addition, the thickness of the upper protective layer is preferably 5 to 50 nm, more preferably 5 to 30 nm.

The material of the reflective layer may be one having a sufficiently high reflectance at the wavelength of regenerating light; more specifically, metals such as Au, Ag, Al, Cu, Ti, Cr, Ni, Pt, Ta, and Pd may be used alone or in combination as alloys. Among them, Au, Ag and Al are preferable as the material of the reflective layer due to higher reflectances. Other elements may be included in addition to the metals described above of a main ingredient; examples of the other elements include metals and semi-metals such as Mg, Se, Hf, V, Nb, Ru, W, Mn, Re, Fe, Co, Rh, Ir, Zn, Cd, Ga, In, Si, Ge, Te, Pb, Po, Sn and Bi.

Materials other than metal may be used such that a thin film of lower refractive index and a thin film of higher refractive index are alternatively superimposed to form a multilayer film, which then may be utilized as the reflective layer.

When the optical recording medium is intended for higher density, among others, Ag based material is often used for the reflective layer by virtue of higher thermal conductivity, higher reflectance, and lower cost. The term “based” means that the content of the atom is 50% or more.

In this connection, when the adjacent layer contains S, it is desirable that a sulfuration preventive layer of a dielectric material etc. containing no S is provided between the reflective layer and the adjacent layer, since sulfuration of Ag may degrade the reflective layer, as disclosed in Patent Literature 5.

However, in the case of the recordable optical recording media such as HD DVD-R and BD-R, the reflectance at recording portions is designed to be lower than that of conventional CD-R and DVD±R, in accordance with the specification (e.g. reflectance specification of DVD+R is 45% to 80%, meanwhile 11% to 24% in BD-R specification and 14% to 28% in HD DVD-R specification), therefore, there exists a problem that the recording sensitivity tends to degrade due to an excessively high reflectance when an Ag reflective layer is employed (not meaning that the Ag reflective layer cannot satisfy the specification).

As described above, when HD DVD-R SL (single layer) or BD-R SL (single layer) is produced using the recording layer that contains bismuth as the main ingredient other than oxygen and contains bismuth oxide, at least the specification values can be satisfied; however, still higher sensitivity is desirable. The high sensitivity is an essential requirement along with increasing the recording linear velocity and multilayer-progress in future. The term “main ingredient” means that the content of bismuth is 40 atomic % or more based on the constitutional elements other than oxygen.

As described above, the reason, why the reflectance comes to excessively high in the recordable optical recording media having a recording layer that contains bismuth as the main ingredient other than oxygen and contains bismuth oxide, is that the recording layer also has a relatively high transmittance even at a wavelength of blue laser.

As such, we have investigated as regards Al alloy for use as the reflective layer that has a high thermal conductivity and a reflectance lower than that of Ag material, and is nonreactive with S in ZnS—SiO₂.

Consequently, it has been confirmed that an Al—Ti alloy (Ti: 0.5 atomic percent) as the reflective-layer material may lead to less defects under high temperature and high humidity conditions compared to Ag reflective layers, and a appropriate reflectance in relation to various specific values as recordable optical recording media suited to blue laser, and thus higher sensitivity can be attained. The reason of Ti content of 0.5 atomic % is described above.

However, it has been found that the Al reflective layer with an additive element of about 1% by mass based on Al may be insufficient in the storage reliability under high temperature and high humidity conditions (for example, degradation of archival properties appears from about 400 hours under 80° C. and 85% RH, although the storage life is not problematic under room temperature).

The reason, why the Al reflective layer losses the storage reliability under high temperature and high humidity conditions, is considered that the graininess increases or surface flatness degrades.

Then the present inventors have evaluated totally with respect to items (i) to (iii) below, as a result have found that the Al reflective layer containing at least one element selected from the group (I) in an amount of 0.6 to 7.0 atomic %, preferably 1.0 to 5.0 atomic %, is very effective.

(i) satisfaction level in terms of specifications (HD DVD-R, BD-R) for recordable optical recording media suited to blue laser,

(ii) improvement of recording sensitivity,

(iii) improvement of storage reliability under high temperature and high humidity conditions.

Elemental Group (I) Mg, Pd, Pt, Au, Zn, Ga, In, Sn, Sb, Be, Ru, Rh, Os, Ir, Cu, Ge, Y, La, Ce, Nd, Sm, Gd, Tb, Dy, Ti, Zr, Hf, Si, Fe, Mn, Cr, V, Ni, Bi, Ag.

When the content of additive elements is set at a higher level compared to conventional Al reflective layers, the following advantages

(a) to (c) may be taken.

(a) rise of reflectance can be suppressed,

(b) rise of reflectance can be suppressed and thermal conductivity decreases, thereby recording sensitivity can be improved,

(c) increase of graininess or degradation of surface flatness can be suppressed.

However, when the content of the element of added to Al is lower than the inventive lower limit, there arise the demerits (d) to (f), and when the content of the element of added to Al is higher than the inventive upper limit, there arise the demerits (g) to (h).

(d) rise of reflectance cannot be suppressed (possibly out of specification),

(e) reflectance rises and thermal conductivity increases, thereby recording sensitivity may be impaired (possibly out of specification),

(f) increase of graininess or degradation of surface flatness may possibly occur,

(g) reflectance decreases rapidly (possibly out of specification),

(h) reflectance decreases and thermal conductivity decreases rapidly, thereby stability of regenerating light degrades.

That is, the inventive content range of additive element to the Al reflective layer may be the range far from impairing the recording-regenerating properties even the reflectance or the thermal conductivity decreases along with increasing the content of additive element to the Al reflective layer in the recordable optical recording media having a recording layer that contains bismuth as the main ingredient other than oxygen and contains bismuth oxide.

The additive element to the inventive Al reflective layer provides an effect to improve the Al graininess or to modify the surface smoothness, therefore, the effect of additive elements themselves is insignificant.

Hence the additive elements to the Al reflective layer may be those conventionally used in the art.

The inventive reflective layer may be formed by vapor deposition, sputtering, or ion plating processes, in particular by sputtering processes. The process to form the reflective layer by the sputtering processes will be explained.

The discharging gas for the sputtering is preferably Ar. As for the sputtering conditions, 1 to 50 sccm of Ar flow rate, 0.5 to 10 kW of power, and 0.1 to 30 seconds of film-forming period are preferable; 3 to 20 sccm of Ar flow rate, 1 to 7 kW of power, and 0.5 to 15 seconds of film-forming period are more preferable; 4 to 10 sccm of Ar flow rate, 2 to 6 kW of power, and 1 to 5 seconds of film-forming period are more preferable.

As for the sputtering conditions, at least one of the Ar flow rate, the power, and the film-forming period is preferably in the ranges, more preferably two or more are in the ranges, still more preferably all of them are in the ranges.

When a light reflective layer is formed under these sputtering conditions, the reflectance may be increased and the corrosion resistance may further be improved, and optical recording media can be obtained with superior recording properties.

The thickness of the reflective layer is preferably 20 to 200 nm, more preferably 25 to 180 nm, particularly preferably 30 to 160 nm. In this connection, the thickness may be other than the ranges described above when the inventive reflective layer is applied to multilayer optical recording media.

When the thickness is lower than 20 nm, there may arise such problems as desirable reflectance is unobtainable, the reflectance decreases during preservation, and/or the recording amplitude is insufficient. When the thickness is above 200 nm, the film surface may be rough and the reflectance may be low; and also such thickness is undesirable in view of productivity.

The film-forming velocity of the reflective layer is preferably 6 to 95 nm/sec, more preferably 7 to 90 nm/sec, particularly preferably 8 to 80 nm/sec. When the film-forming velocity is below 6 nm/sec, oxygen tends to migrate into sputtering atmosphere, thus the reflectance may be low due to oxidation and the corrosion resistance of the reflective layer may be deteriorated. When the film-forming velocity is above 95 nm/sec, the temperature rise may be large and the substrate may bend.

The material of the substrate may be anything as long as having excellent thermal and mechanical properties and also an excellent light-transparency in cases where the recording-regenerating is carried out through the substrate.

Specific examples thereof include polycarbonate, polymethylmethacrylate, amorphous polyolefin, cellulose acetate and polyethylene terephthalate; preferable are polycarbonate and amorphous polyolefin.

The thickness of the substrate depends on the application, and is not limited specifically. Guide grooves or guide pits for tracking, and also preform mats of address signals may be formed on the surface of the substrate. In addition, a UV ray curable resin layer or an inorganic thin film may be formed on the mirror side (opposite to guide grooves etc.) of the substrate for the purpose of protecting surface or preventing deposition of dusts etc.

We have investigated vigorously with respect to technical objects to assure the stability of tracking servo, regenerating stability of address information using wobble, and regenerating stability of information recorded as prepit in system lead-in regions and to maintain practical recording properties as for optical recording media suited to blue laser in particular, consequently, we have found that these objects may be attained by setting the groove width of wobbled guide grooves into 170 to 230 nm and the groove depth into 23 to 33 nm. The substrates of disc-shape optical recording media are typically produced by injection-molding processes, therefore, the depth of prepit at system lead-in regions and the depth of wobbled guide grooves are usually made identical for convenience of molding processes. Therefore, the groove depth of guide grooves is also the prepit depth, thus the groove depth of guide grooves should be designed such that it is also allowable for the prepit depth.

As for the recordable optical recording media suited to HD DVD-R specification, the track pitch is preferably 0.4±0.02 μm, and the amplitude level of wobbles is preferably 16±2 nm.

A protective layer may be formed on the reflective layer or the cover layer (or light transmitting layer). The material of the protective layer may be anything as long as capable of protecting the reflective layer or the cover layer from external force. Organic materials are exemplified by thermoplastic resins, thermosetting resins, electron beam-curable resins and UV ray-curable resins. Inorganic materials are exemplified by SiO₂, Si₃N₄, MgF₂ and SnO₂.

Thermoplastic resins or thermosetting resins may be applied by dissolving them into an appropriate solvent to prepare a liquid, then coating and drying the liquid. UV ray-curable resins may be applied by coating the liquid directly or after dissolving into an appropriate solvent, followed by irradiating UV rays and curing it.

Examples of the UV ray curable resins include acrylate resins such as urethane acrylate, epoxy acrylate and polyester acrylate. These materials may be used alone or after mixing, and applied as one layer or plural layers.

The process to form the protective layer may be coating processes such as spin coating processes and casting processes, sputtering processes, or chemical vapor deposition processes; among these, spin coating processes are preferable as regards organic materials. The thickness of the protective layer is typically 0.1 to 100 μm, preferably 3 to 30 μm in cases of organic materials.

The cover layer (light transmitting layer) is required when a high-NA lens is employed for high density. For example, when NA is raised, the portion where the regenerating light transmits should be made thinner.

This is because that the raised NA leads to less aberration allowance that corresponds to a shift angle between the vertical line of the disc face and the optical axis of a pick up (so-called tilt angle that is proportional with square of the product between the inverse number of light-source wavelength and aperture number of the objective lens), and the tilt angle is likely to be affected by the aberration related with the substrate thickness. Therefore, the influence of the aberration on the tilt angle is mitigated by making thin the substrate.

As such, an optical recording is proposed in which irregularities are formed on a substrate, for example, to form a recording layer, on which then a reflective layer is provided, on which then a light-transmissive cover layer is formed, and information on the recording layer is regenerated by irradiating a regenerating light from the side of the cover layer; an optical recording is proposed in which an optical recording is proposed in which a reflective layer is formed on a substrate, on which then a recording layer is provided, on which then a light-transmissive cover layer is formed, and information on the recording layer is regenerated by irradiating a regenerating light from the side of the cover layer (Blu-ray specification).

In this way, the raised-NA of objective lenses may be addressed by thinning the cover layer. That is, the recording density may be increased still more by way of providing a thin cover layer and recording-regenerating from the side of the cover layer.

Such a cover layer is typically formed from polycarbonate sheet or UV-ray curable resins. The inventive cover layer may contain a layer to adhere the cover layer.

Another substrate may be laminated to the reflective layer (or protective layer thereon) or to the cover layer (or protective layer thereon), or two sheets of optical recording medium may be laminated while facing inside the reflective layer or the cover layer.

The material of the adhesive layer used for the laminating may be adhesives such as UV ray curable resins, hot-melt adhesives and silicone resins. The material of the adhesive layer is coated on the reflective layer or overcoat layer by spin coating, roll coating, or screen printing processes, depending on the material, and then laminated to the opposing face of discs after treating by UV ray irradiation, heating or pressing.

The disc of the opposing face may be a similar mono-plate disc or only a transparent substrate; the laminating face of the opposing face of discs may or may not be coated with the material of adhesive layer. A pressure-sensitive adhesive sheet may be used as the adhesive layer.

The thickness of the adhesive layer is not limited specifically, preferably, the thickness is 5 to 100 μm in view of coating ability of materials, curing ability, and mechanical properties of discs.

The range of adhesive face is also not limited definitely; it is desirable that the site of inner periphery edge is Φ15 to 40 mm, more preferably Φ15 to 30 mm for adequate adhesive strength when applied to optical recording media in accordance with HD DVD-R specification.

The process to record on the inventive optical recording medium will be explained more specifically in the following.

In the present invention, recording marks are formed by heating the recording layer to above the temperature to initiate forming recording marks by use of a recording strategy that has a preheating step followed by a heating step.

By this way, recording quality may be enhanced also in the wavelength region of blue laser, since the recording layer is promptly heated to the temperature to initiate forming recording marks when forming recording marks and the recording marks are formed on the recording layer with high accuracy. When the preheating power (Pb) has an intensity of 70% or less of the recording power (Pw), the preheating power can be maintained at a proper intensity, and sufficient recording quality may be obtained such that PRSNR and jitter are satisfactory for specifications, without spreading excessively the leading portions of the recording marks. When above 70%, sufficient recording quality cannot be obtained such that PRSNR is low or jitter is high, and resulting in out of specification. That is, the preheating power is excessively intense, therefore, causing deterioration of PRSNR.

Furthermore, the fluctuation of the size of the resulting recording marks may be appropriately addressed by way of controlling the preheating condition by preheating pulse.

The preheating power (Pb) should be more intense than the regenerating power (Pr). When the preheating power is no more than the regenerating power, the temperature rise is delayed even though the recording power is intense, thus the shape of the recording marks fluctuates and the recording quality degrades. In order to assure the effect of the preheating step, it is preferred that the preheating power (Pb) is more intense than the regenerating power (Pr) by 0.7 mW or more.

PRSNR is an abbreviation of Partial Response Signal to Noise Ratio that is an index expressing a signal quality based on HD DVD standard, and the specification value requires to be 15 or more.

The recordable optical recording medium, with which the inventive recording method is carried out, can record and regenerate by use of blue laser and has excellent optical properties such as light-absorbing capacity and recording capacity. The optical recording medium can record with higher quality by applying the inventive recording method even when the recording polarity is “high to low”.

In cases where a cooling step is carried out after the heating step, the cooling power (Pc) is made lower than the preheating power (Pb). Consequently, the recording marks are suppressed to spread excessively at the rear portions of recording marks and the recording marks are formed with high accuracy, thus the recording quality is such that PRSNR and jitter are sufficiently satisfactory in relation to the specifications. In order to assure the effect of the cooling step, it is preferred that the cooling power (Pc) is lower than the preheating power (Pb) by 1.0 mW or more.

It is preferred that the preheating pulse contains two or more species of pulses having different powers each other. Irradiation of such a preheating pulse may make proper the recording strategy, thus the preheating condition can be appropriately controlled precisely, the temperature can be promptly heated above the temperature to initiate forming recording marks when forming recording marks, and recording marks are formed at the recording layer with a higher accuracy, even when the size of recording marks to be recorded changes at the recording layer.

Furthermore, the recording pulse may be a monopulse, consequently, shorter recording marks suited to blue laser may be formed, and also recording marks can be formed with higher sensitivity (lower power), even at high-speed recording necessary for an intense recording power.

Furthermore, the recording power of the monopulse may be changed into two or more species depending on the length of recording marks to be formed. In the high-speed recording suited to blue laser, it is more difficult to form shorter recording marks than to form longer recording marks. When two or more species of recording power are employed and more intense recording power is used at forming shorter recording marks, shorter recording marks can be formed accurately even at high-speed recording.

Furthermore, the recording pulse may be a combination of two or more power rather than a monopulse. When the power of recording pulse is changed at forming recording marks, high quality recording marks can be formed without spreading the backward of recording marks in particular.

The preheating step, the subsequent heating step, and the still subsequent cooling step at forming recording marks in the inventive recording method will be explained with reference to figures.

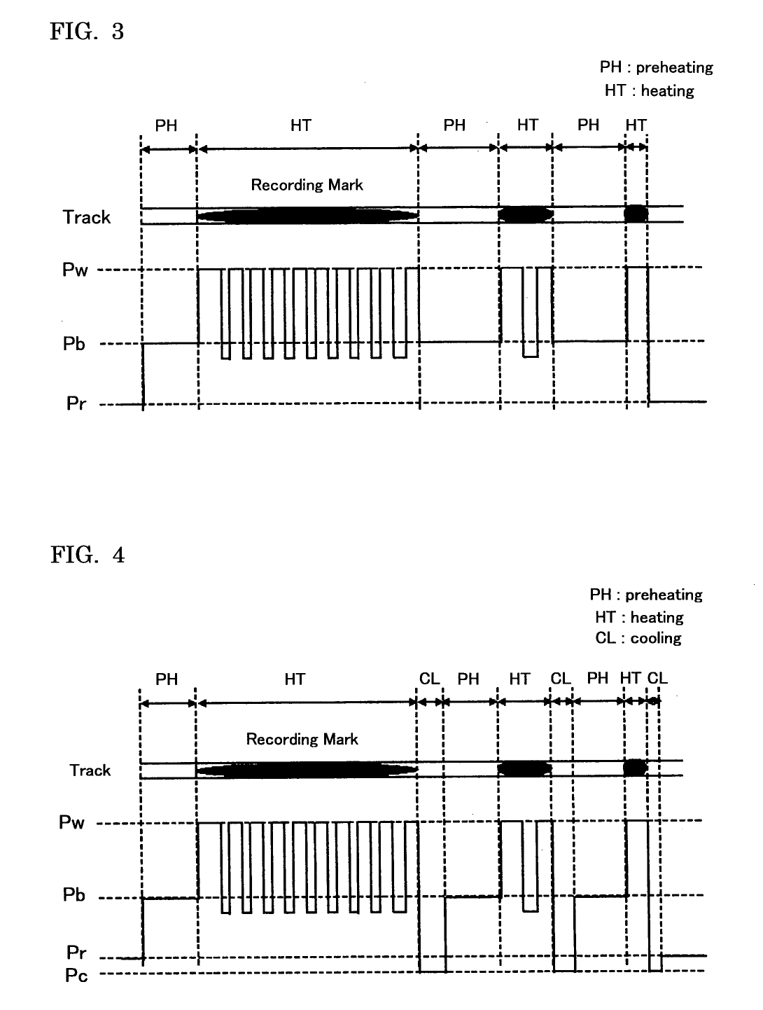

FIGS. 3 to 6 are schematic views that explain the preheating step, the subsequent heating step, and the still subsequent cooling step.

FIG. 3 exemplifies that the recording layer is preheated in the preheating step through applying a preheating power Pb that is higher than the regenerating power Pr and lower than the recording power Pw (Pb is no less than 70% of Pw), then the recording power Pw is applied that corresponds to the recording marks to be formed, thereby a recording mark is formed on a track.

FIG. 4 exemplifies that the cooling of the recording layer is prompted after forming the recording mark through applying a cooling power Pc weaker than the preheating power Pb, subsequent to the preheating and the heating steps of FIG. 3.

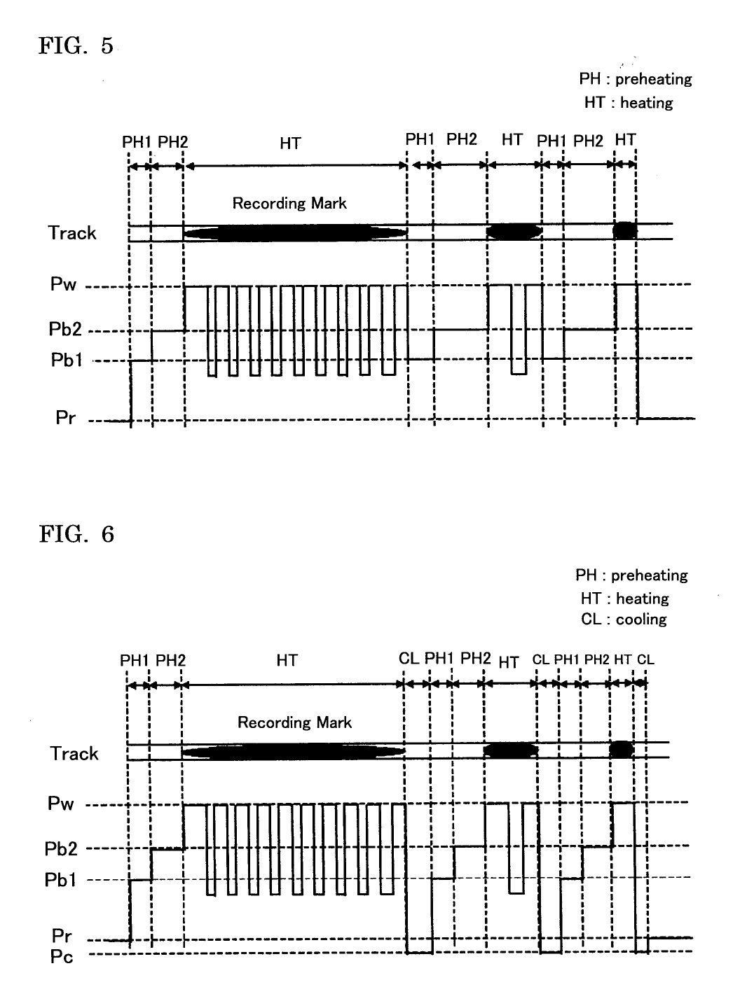

FIGS. 5 and 6 exemplify that the preheating power in the preheating step is divided into the first preheating power Pb1 and the second preheating power Pb2 such that the preheating power is applied in more segmentalized manner than those of FIGS. 3 and 4, then the recording power Pw is applied to form a recording mark on the track. In this connection, the present invention is not limited to the examples shown in FIGS. 5 and 6, and also the step number of preheating power may be increased still more.

In the examples shown in FIGS. 3 and 5, a preheating pulse is irradiated, the recording layer is preheated to a temperature below the temperature at which recording marks initiate to form, then a recording pulse is irradiated based on information to be recorded to heat above the temperature at which recording marks initiate to form, thereby recording marks are formed. In the examples shown in FIGS. 4 and 6, a cooling pulse is further irradiated thereby to prompt cooling the recording layer.

When the heating is carried out by use of a preheating pulse and a recording pulse in order, the recording layer can be heated above the temperature at which recording marks initiate to form; furthermore, the cooling of the recording layer can be prompted by use of a cooling pulse.

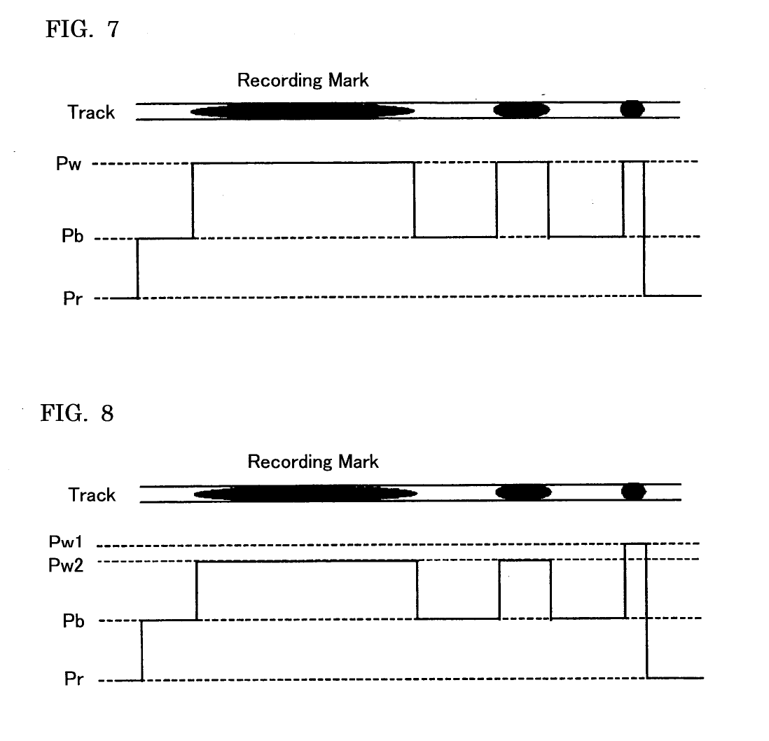

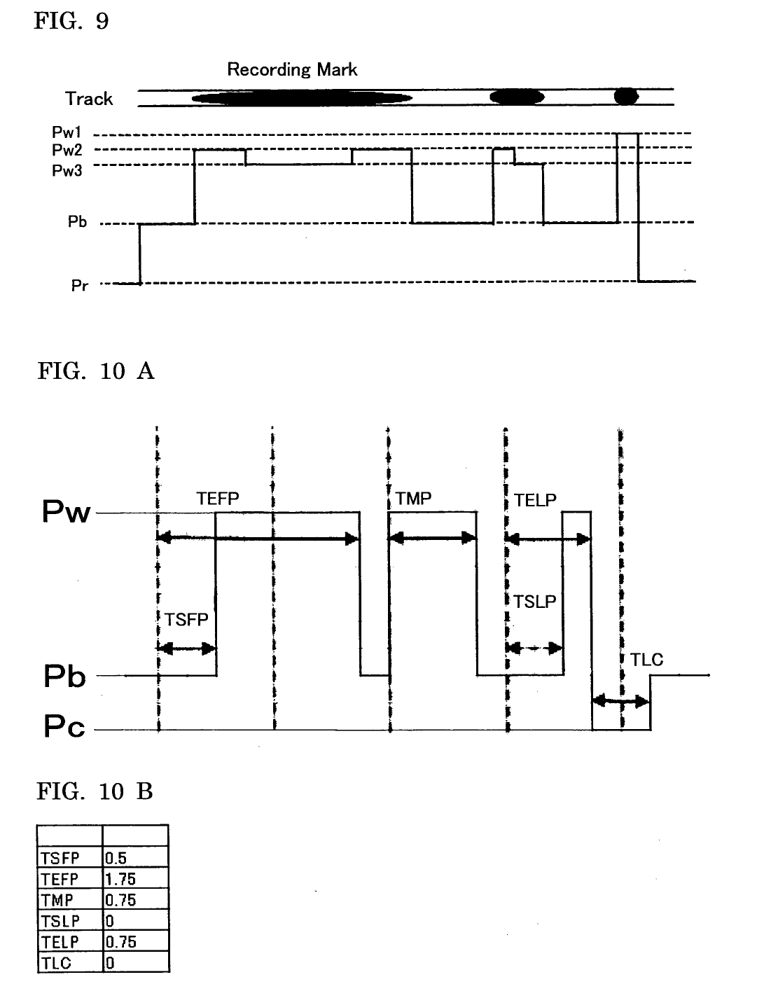

Furthermore, the recording pulse may be a monopulse as shown in FIGS. 7 and 8, or a combination pulse of two or more species of power as shown in FIG. 9.

Shorter recording marks are unlikely to form eyedrop-like marks through spreading the backward of recording marks compared to longer recording marks, therefore, it is preferred the recording is carried out by a monopulse thereby recording marks can be formed with high sensitivity (low power) at high speed recording.

When two or more species of recording power are employed to record, the backward of longer recording marks in particular can be far from spreading, thus making possible to form high quality recording marks.

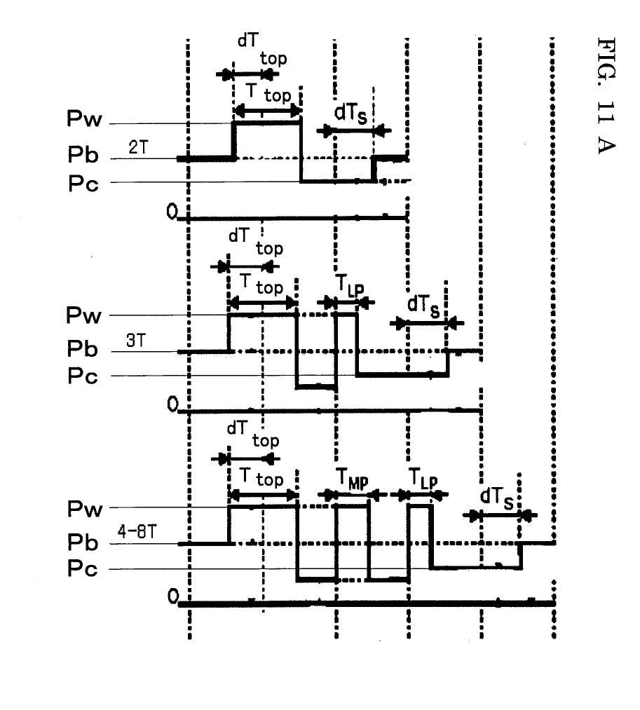

Specific examples of recording pulse utilized in actual recording are the pulse patterns shown in FIGS. 10 A to 13 B. One species of pulse width is shown respectively in FIGS. 10 A to 13 B; the respective patterns are not limited to the pulse width, but the pulse width may be optionally selected so as to form high-quality recording marks.

In accordance with the present invention, recordable optical recording media can be provided that are equipped with an inorganic recording layer capable of forming recording marks with excellent accuracy even at a wavelength region of blue laser and capable of recording with superior recording quality; in particular, the recordable optical recording media that are equipped with an inorganic recording layer having bismuth oxide can attain higher recording sensitivity, improve recording properties in terms of PRSNR, jitter, error rate; etc., and enhance storage stability still more under high temperature and high humidity conditions. In addition, a recording method can be provided that is adaptable to optical recording media, in particular to those having a recording polarity of “high to low”.

### EXAMPLES

The present invention will be explained in more detail with reference to Examples and Comparative Examples, to which the present invention should in no way be limited.

### Examples 1 to 9

A recordable optical recording medium was produced as follows: a polycarbonate substrate (by Mitsubishi Engineering-Plastics Co., Yupilon H-4000) of 0.6 mm thick and 120 mm diameter having wobbled guide grooves of wobble amplitude 16±1 nm (groove depth: see Table 1, groove width: full width at half maximum 205±5 nm, top 165±15 nm, bottom 265±20 nm, track pitch: 0.4±0.02 μm) was prepared through an injection molding process by combining a toggle-type molding machine (by Sumitomo Heavy Industries, Ltd.) and a metal mold (for a disc substrate of 0.6 mm thick and 120 mm diameter, by Seikoh Giken Co.); on the surface of the guide groove, a lower protective film of 60 nm thick of ZnS—SiO₂ (80:20% by mole), a recording layer of 16 nm thick of Bi and B and O, an upper protective layer of 20 nm thick of ZnS—SiO₂ (80: 20% by mole), a reflective layer of 40 nm thick of an AlTi alloy (Ti 1.0% by mass) (Examples 1 to 5, and 9) or a reflective layer of 80 nm thick of an AgNdBi alloy (Ag:Nd:Bi=96.5:3.0:0.5 by atomic %) (Examples 6 to 8) were formed in order by way of a sputtering process using a sputtering apparatus (DVD splinter, by Elicon Co.), and on which then a polycarbonate substrate (by Mitsubishi Engineering-Plastics Co., Yupilon H-4000) of 0.6 mm thick was laminated using a UV curable resin (by Nippon Kayaku Co., KAYARAD DVD-802), thereby to form a recordable optical recording medium of about 1.2 mm thick as shown in FIG. 1 (except for an overcoat layer).

In addition, a polycarbonate substrate having wobbled guide grooves (groove depth: 26 nm, groove width: see Table 2 (converted into a full width at half maximum per a radius site), track pitch: 0.4±0.02 μm) was prepared in a similar manner as Example 1, and a recordable optical recording medium (Example 10) was prepared in the similar manner as Example 1 using the substrate.

The recordable optical recording media of Examples 1 to 10 were recorded in accordance with HD DVD-R specification (DVD Specifications for High Density Recordable Disc (HD DVD-R) Version 1.0) by use of an optical disc evaluation device ODU-1000 (by Pulsetec Industrial Co., wavelength 405 nm, NA 0.65) and the properties were evaluated.

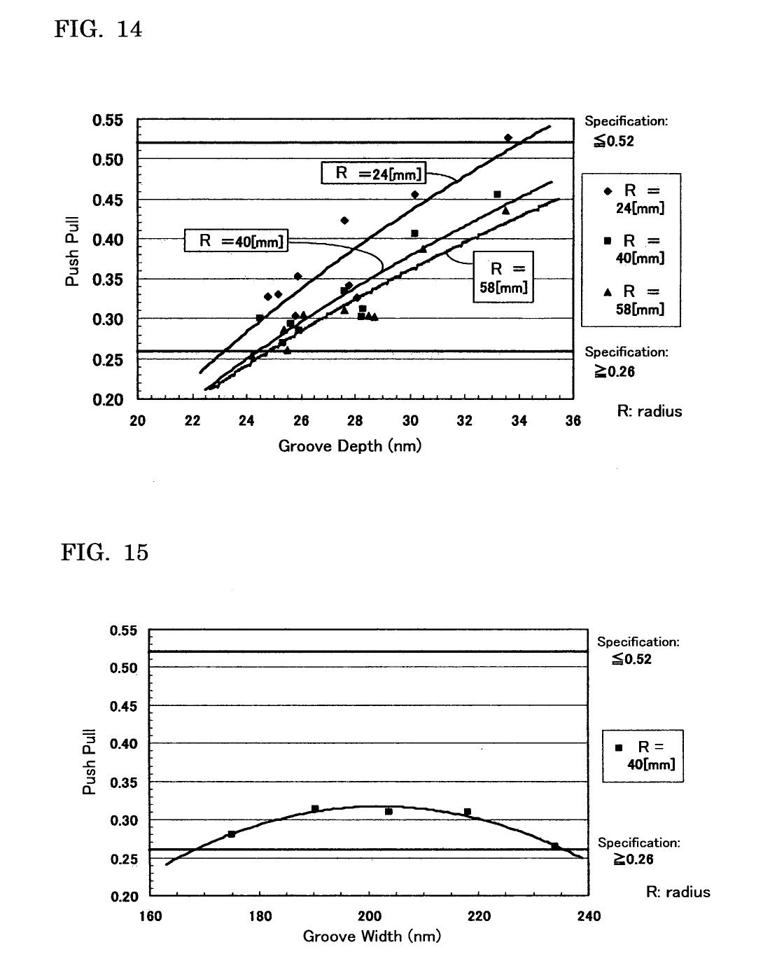

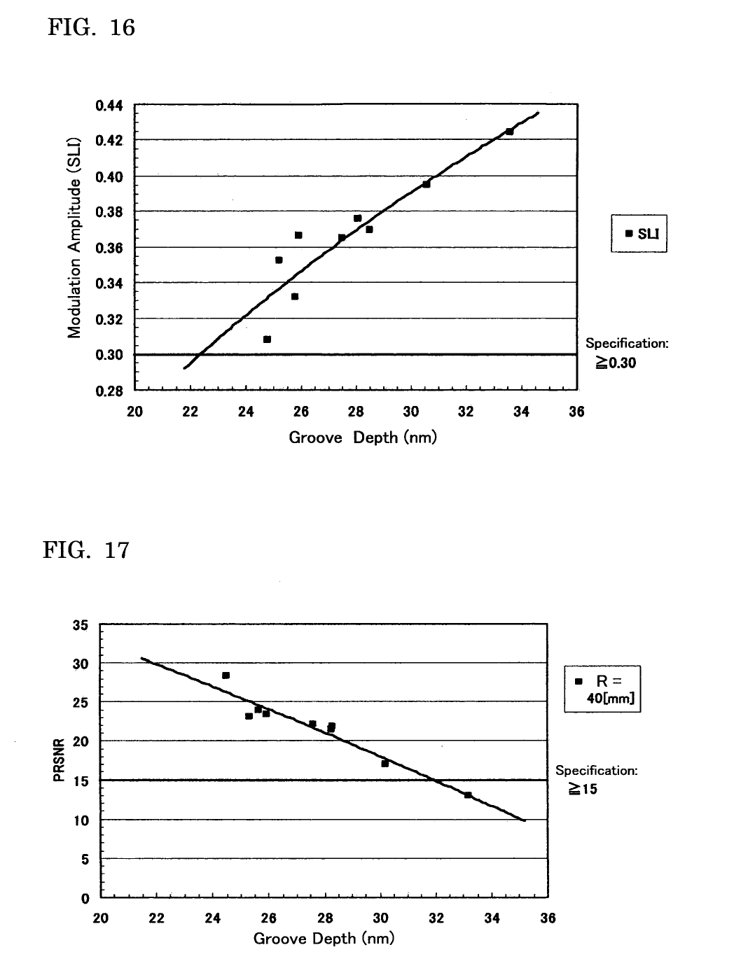

The results are shown in Tables 1 and 2, FIGS. 14 to 18 (Example 10: only in Table 2). The somewhat thick linear lines running across FIGS. 14 to 18 represent each a specification value.

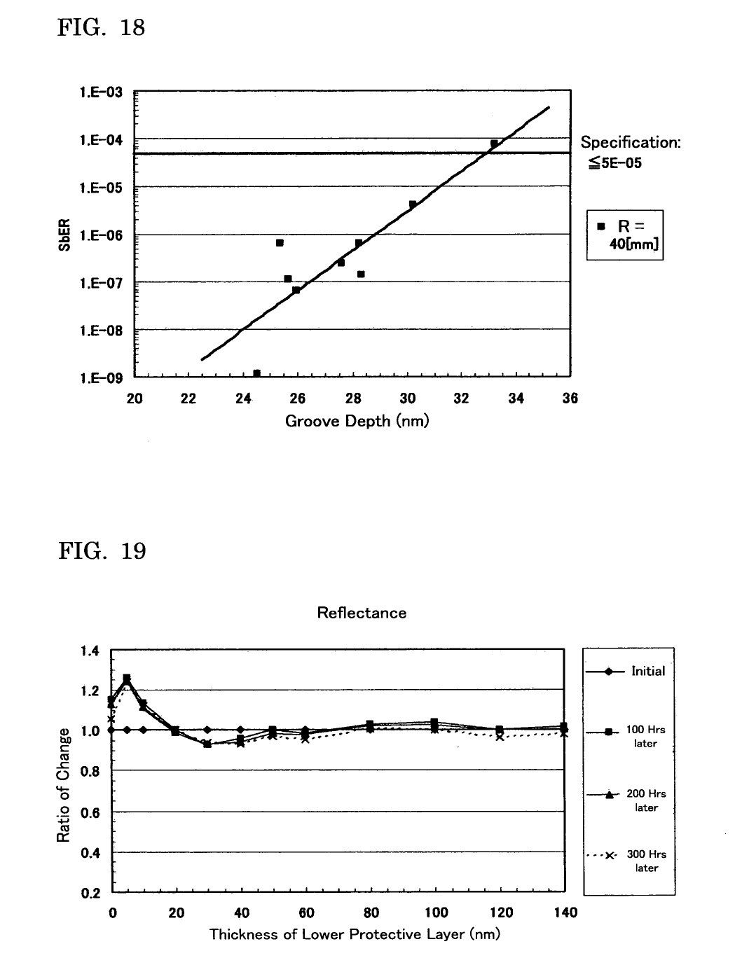

The term “PRSNR” in FIG. 17 is an abbreviation of “Partial Response Signal to Noise Ratio”, and the term “SbER” in FIG. 18 is an abbreviation of “Simulated bit Error Rate”.

It is demonstrated from FIGS. 14 to 18 that the results of measured properties are affected by the groove depth and the groove width of guide grooves, and the push-pull within specification corresponds to groove depth 23 to 33 nm at inner circumferential portion, groove depth 24.5 nm or more at middle circumferential portion, and groove depth 25 nm or more at outer circumferential portion. The results are within specification as regards PRSNR of the middle circumferential when the groove depth being 32 nm or less and as regards SbER when the groove depth being 33 nm or less.

The modulation amplitude at SLI (system lead-in) region is within specification when the groove depth being 23 nm or more. The push-pull is within specification when the groove depth being 170 to 230 nm at middle circumference.

Contents data was recorded and regenerated with respect to recordable optical recording media of Example 1 to 10 by use of an optical recording apparatus (by Toshiba Co., RD-A1), consequently, all of the recordable optical recording media could be recorded without stopping the record on the way and the recorded data could be regenerated.

Accordingly, even out of specification appeared somewhat in some cases, the recording and regeneration could be carried out using the optical recording apparatus.

TABLE 1

| | groove depth (nm) | | | | | | | | recording | | |
|---|---|---|---|---|---|---|---|---|---|---|---|
| | r = | | | | MD | | | | property | | |
| | 23.5 | | | | r = 23.5 mm | push-pull | | | PRSNR | SbER | |
| | mm (SLI) | r = 24 mm | r = 40 mm | r = 58 mm | (SLI) | r = 24 mm | r = 40 mm | r = 58 mm | r = 40 mm | r = 40 mm | RR |
| Ex. 1 | 25.8 | 25.8 | 26.0 | 26.1 | 0.33 | 0.30 | 0.29 | 0.31 | 23.4 | 6.50E−08 | A |
| Ex. 2 | 25.9 | 25.9 | 25.7 | 25.4 | 0.37 | 0.35 | 0.29 | 0.29 | 23.9 | 1.10E−07 | A |
| Ex. 3 | 25.2 | 25.2 | 25.4 | 25.5 | 0.35 | 0.33 | 0.27 | 0.26 | 23.1 | 6.40E−07 | A |
| Ex. 4 | 28.1 | 28.1 | 28.3 | 28.5 | 0.38 | 0.33 | 0.31 | 0.30 | 21.9 | 1.40E−07 | A |
| Ex. 5 | 27.5 | 27.6 | 27.6 | 27.6 | 0.37 | 0.42 | 0.33 | 0.31 | 22.1 | 2.40E−07 | A |
| Ex. 6 | 28.5 | 27.8 | 28.3 | 28.7 | 0.37 | 0.34 | 0.30 | 0.30 | 21.4 | 6.30E−07 | A |
| Ex. 7 | 30.6 | 30.2 | 30.2 | 30.5 | 0.40 | 0.46 | 0.41 | 0.39 | 17.0 | 4.20E−06 | A |
| Ex. 8 | 33.6 | 33.6 | 33.2 | 33.5 | 0.42 | 0.53 | 0.46 | 0.44 | 13.0 | 7.50E−05 | A |
| Ex. 9 | 24.8 | 24.8 | 24.5 | 24.2 | 0.31 | 0.33 | 0.30 | 0.25 | 28.4 | 1.20E−09 | A |

| | | | | |
|---|---|---|---|---|
| SP | ≧0.30 | 0.26 to 0.52 | ≧15 | ≦5.0E−05 |

RR: recording and regeneration,
MD: modification degree,
r: radius,
SP: specification

TABLE 2

| | groove width (nm) | push-pull | optical recording |
|---|---|---|---|
| | radius = | radius = | apparatus recording - |
| | 35 to 45 mm | 35 to 45 mm | regenerating |
| Ex. 10 | 175 | 0.28 | A |
| | 190 | 0.31 | |
| | 204 | 0.31 | |
| | 218 | 0.31 | |
| | 234 | 0.27 | |

### Example 11

A recordable optical recording medium was prepared in the same manner as Example 1 except that the thickness of the lower protective layer of ZnS—SiO₂ (80:20% by mole) was changed within a range of 0 to 140 nm (the thickness 0 nm corresponds to no lower protective layer).

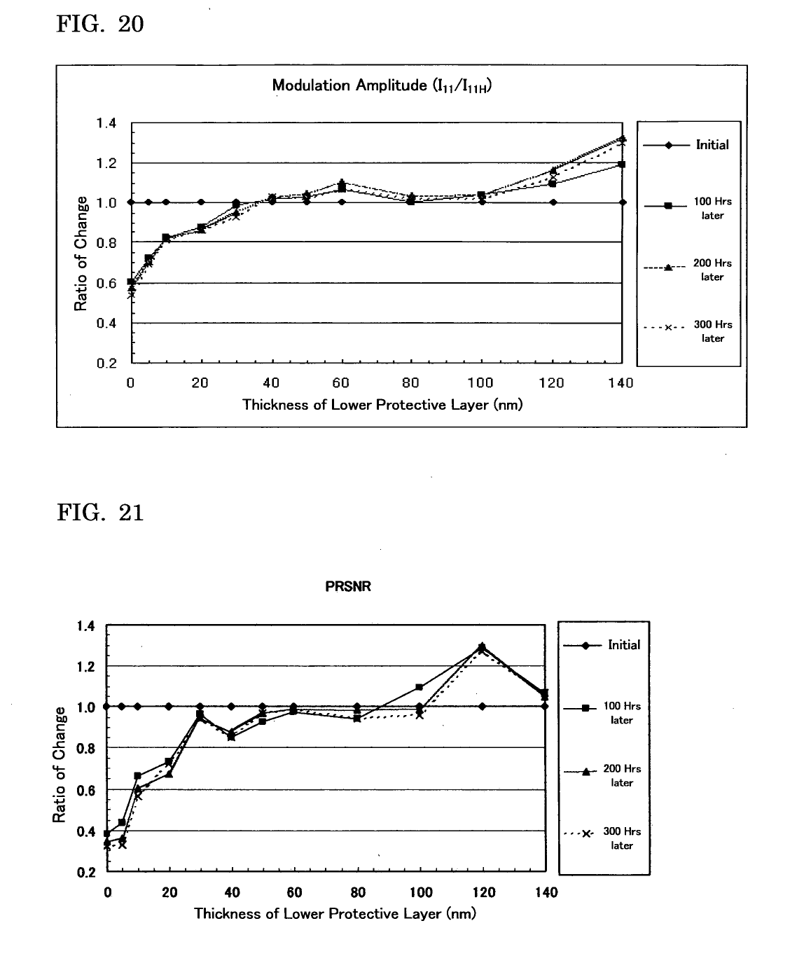

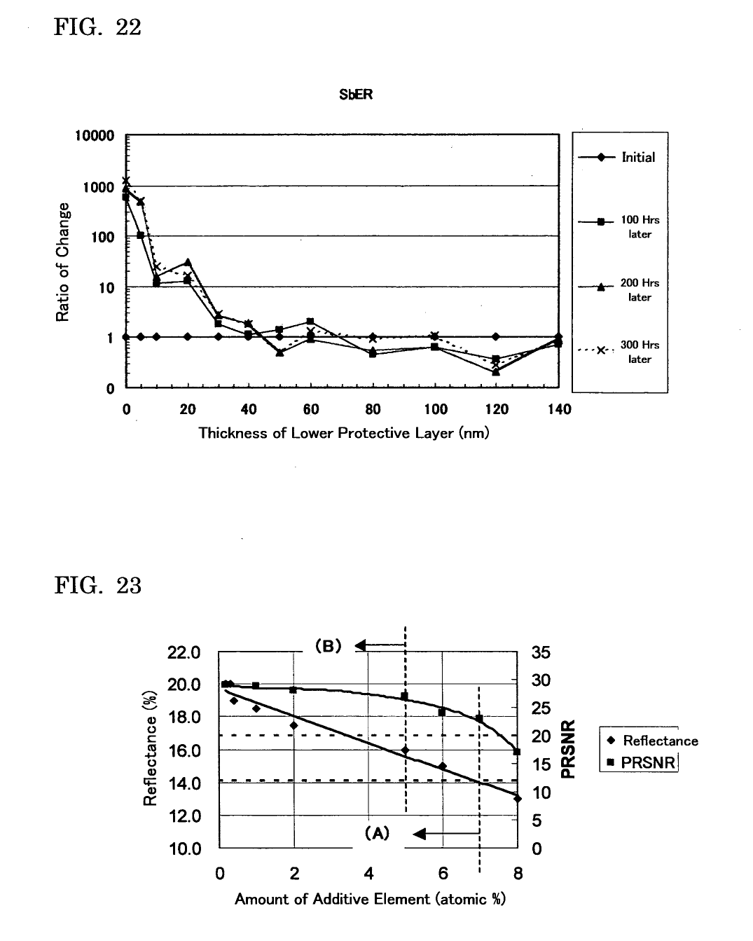

The resulting recordable optical recording medium was evaluated in terms of properties at the recording portion by use of an optical disc evaluation device ODU-1000 (by Pulsetec Industrial Co., wavelength 405 nm, NA 0.65) and the properties were evaluated. Then an environmental test was carried out after storing at 80° C. and 85% RH for 100 hours and the properties were evaluated, these procedures were repeated per 100 hours, and the environmental test and property evaluation were carried out after 300 hours in total. The results are expressed in FIGS. 19 to 22, in which the results of the respective tests were expressed in terms of ratios, comparing with those of before the environmental test (initial value) and considering the initial value as 1.

From FIGS. 19 to 22, it is demonstrated that the thickness of 20 nm or more is necessary on the basis of reflectance and the thickness of 30 nm or more is necessary on the basis of modulation amplitude, PRSNR, or SbER in order to suppress the degradation of properties when the lower protective layer is of ZnS—SiO₂ (80:20% by mole).

### Examples 12 to 18 and Comparative Examples 1 to 2

On a polycarbonate substrate (by Mitsubishi Engineering-Plastics Co., Yupilon H-4000) of 0.6 mm thick and having a guide groove of 26 nm deep, which being injection-molded by use of the molding machine and the metal mold of Example 1, the following layers were laminated in order using a sputtering apparatus (DVD splinter, by Elicon Co.).

lower protective layer (ZnS—SiO₂, 80:20 by mole), 50 nm thick, recording layer (Bi₂BOₓ), 15 nm thick,

upper protective layer (ZnS—SiO₂, 80:20 by mole), 20 nm thick, reflective layer (Al—Ti alloy, composition: Table 3), 60 nm thick.

The composition of recording layers was measured by RBS (Rutherford Back-Scattering Spectrometry) and it was confirmed that Bi did not completely oxidized.

Then an organic protective layer of about 5 μm thick was provided from a UV curable resin (by Nippon Kayaku Co., KAYARAD DVD-802) on the Al alloy reflective layer by a spin coating process and a dummy substrate of 0.6 mm thick was laminated using a UV curable resin to prepare a recordable optical recording medium as shown in FIG. 1.

TABLE 3

| | additive | added amount of |
|---|---|---|
| Example | element to Al | element (atomic %) |
| Ex. 12 | Ti | 0.6 |
| Ex. 13 | Ti | 0.8 |
| Ex. 14 | Ti | 1.0 |
| Ex. 15 | Ti | 2.0 |
| Ex. 16 | Ti | 5.0 |
| Ex. 17 | Ti | 6.0 |
| Ex. 18 | Ti | 7.0 |
| Com. Ex. 1 | Ti | 0.5 |
| Com. Ex. 2 | Ti | 8.0 |

The recordable optical recording media of Examples 12 to 18 and Comparative Examples 1 to 2 were recorded in accordance with HD DVD-R specification (DVD Specifications for High Density Recordable Disc (HD DVD-R) Version 1.0) by use of an optical disc evaluation device ODU-1000 (by Pulsetec Industrial Co., wavelength 405 nm, NA 0.65), and the reflectance at recording portions and PRSNR were evaluated.

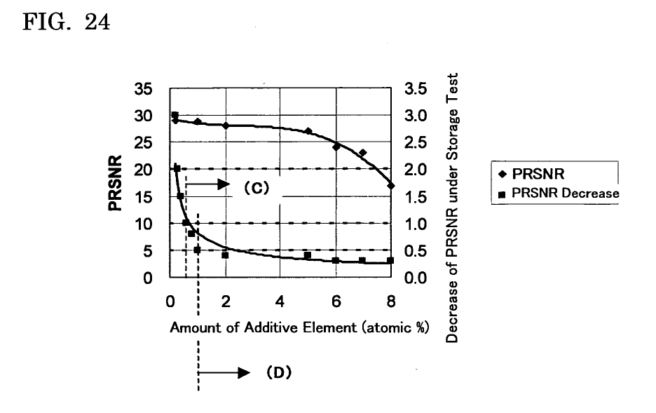

PRSNR was measured with respect to recorded samples after allowing to stand at 80° C. and 85% RH for 300 hours and compared with initial PRSNR. The results are shown in FIGS. 23 to 24. The dotted lines of traverse direction in FIGS. 23 and 24 represent a specification value.

The results of FIG. 23 demonstrate that the content of added elements of 7.0 atomic % or less (region of (A) in FIG. 23) results in a reflectance that satisfies the HD DVD-R specification. As such, the effectiveness of the upper limit of the present invention could be confirmed in terms of the range of the content of added elements.

The sensitivity represented a tendency similar as the reflectance respect to the content of added elements, that is, the content of added elements of 0.6 to 7.0 atomic % results in a recording sensitivity that satisfies the HD DVD-R specification.

In addition, there is such a tendency that as the content of added elements increases, PRSNR decreases along with the decrease of the thermal conductivity and reflectance; however, the level of decrease is approximately negligible at the content of added elements of 5.0 atomic % or less (region of (B) in FIG. 23). As such, the effectiveness of the preferable upper limit of the present invention could be confirmed in terms of the range of the content of added elements.

The results of FIG. 24 demonstrate that the decrease of PRSNR after allowing to stand at 80° C. and 85% RH for 300 hours can be prevented by increasing the content of added elements.

The results of FIG. 24 demonstrate that the decrease of PRSNR comes to 1.0 or less at the content of added elements of 0.6 atomic % or more after allowing to stand at 80° C. and 85% RH for 300 hours; as such, the effectiveness of the lower limit of the present invention could be confirmed in terms of the range of the content of added elements (region of (C) in FIG. 24).

In addition, the decrease of PRSNR comes to 0.5 or less at the content of added elements of 1.0 atomic % or more after allowing to stand at 80° C. and 85% RH for 300 hours; as such, the effectiveness of the lower limit of the present invention could be confirmed in terms of the range of the content of added elements (region of (D) in FIG. 24).

There also appears such a tendency that the content of elements added to Al of 7.0 atomic % or more results in excessive decrease of reflectance and also degradation of stability against regenerating light. Examples 19 to 25 and Comparative Examples 3 to 4

Recordable optical recording media were prepared in the same manner as Example 12 except that the species and the content of elements added to Al were changed as shown in Table 4, and the evaluation items were measured in the same manner as Example 12. The results are shown in Table 4.

In Table 4, the evaluation results mean as follows:

A: optimum recording power as well as reflectance, when recorded with the optimum recording power, satisfy HD DVD-R specification,

B: at least one of optimum recording power and reflectance, when recorded with the optimum recording power, does not satisfy HD DVD-R specification.

In addition, decrease of PRSNR (archival property) after allowing to stand at 80° C. and 85% RH for 300 hours was evaluated as follows:

A: decrease of PRSNR after 300 hours at 80° C. and 85% RH is 1.0 or less based on PRSNR before storage,

B: decrease of PRSNR after 300 hours at 80° C. and 85% RH is above 1.0 based on PRSNR before storage.

TABLE 4

| | additive | added amount | | |
|---|---|---|---|---|
| | element | of element | reflectance/ | increase of |
| Example | to Al | (atomic %) | sensitivity | PRSNR *1) |
| Ex. 19 | Cr | 2.0 | A | A |
| Ex. 20 | Pd | 2.0 | A | A |
| Ex. 21 | Sn | 2.0 | A | A |
| Ex. 22 | Cu | 2.0 | A | A |
| Ex. 23 | Mn | 2.0 | A | A |
| Ex. 24 | Si | 2.0 | A | A |
| Ex. 25 | Mg | 2.0 | A | A |
| Com. Ex. 3 | Cr | 0.2 | A | B |
| Com. Ex. 4 | Cr | 8.0 | B | A |

*1) after 300 hours at 80° C. and 85% RH

The results described above demonstrate the inventive effectiveness of the range of content of elements that are added to Al in the recordable optical recording media having a recording layer that contains bismuth as the main ingredient other than oxygen and contains bismuth oxide.

### Comparative Examples 5 to 7

Recordable optical recording media were prepared in the same manner as Example 12 except that the material of the reflective layer was changed into those shown in Table 5, and the evaluation items were measured in the same manner as Example 12. The results are shown in Table 5.

It is understood from Table 5 that the reflectance is higher compared to those of inventive Al reflective layers, and the recording sensitivity is above the upper limit of HD DVD-R specification.

In addition, decrease of PRSNR (archival property) after allowing to stand at 80° C. and 85% RH for 300 hours was 10 or more based on PRSNR before storage, and many defects like whisker generated in regenerating signals, which was believed due to Ag sulfuration.

TABLE 5

| | | added amount | | |
|---|---|---|---|---|
| Comparative | reflective | of element | reflectance/ | increase of |
| Example | layer | (atomic %) | sensitivity | PRSNR *1) |
| Com. Ex. 5 | Ag | 0.0 | B | B |
| Com. Ex. 6 | AgNd | 0.4 | B | B |
| Com. Ex. 7 | AgNd | 2.0 | A | B |

*1) after 300 hours at 80° C. and 85% RH

### Examples 26 to 31

Recordable optical recording media were prepared in the same manner as Example 12 except that the materials of the reflective layer and the recording layer were changed into those shown in Table 6, and the evaluation items were measured in the same manner as Example 12. The results are shown in Table 6.

As shown in Table 6, all of the recording layers satisfy HD DVD-R specification in terms of the reflectance and the recording sensitivity, and decrease of PRSNR (archival property) after allowing to stand at 80° C. and 85% RH for 300 hours is 1.0 or less based on PRSNR before storage.

That is, it is demonstrated that the effect of elements added to the inventive Al reflective layer is effective for the recording layer that contains bismuth as the main ingredient other than oxygen and contains bismuth oxide and also for the recordable optical recording media in which the recording layer and the inventive Al reflective layer are laminated through a layer mainly containing ZnS—SiO₂.

TABLE 6

| | | added | | | |
|---|---|---|---|---|---|
| | additive | amount | material of | | increase |
| | element | of element | recording | reflectance/ | of PRSNR |
| Example | to Al | (atomic %) | layer | sensitivity | *1) |
| Ex. 26 | Ti | 2.0 | Bi₂CuOx | A | A |
| Ex. 27 | Ti | 2.0 | Bi₂FeOx | A | A |
| Ex. 28 | Ti | 2.0 | Bi₂ZnOx | A | A |
| Ex. 29 | Ti | 2.0 | Bi₂PdOx | A | A |
| Ex. 30 | Ti | 2.0 | BiBOx | A | A |
| Ex. 31 | Ti | 2.0 | Bi₂GeOx | A | A |

*1) after 300 hours at 80° C. and 85% RH

In the Examples described above, the effect of recordable optical recording media could be confirmed from the construction of HD DVD-R shown in FIG. 1; and similar results could be obtained from the BD-R construction shown in FIG. 2.

### Examples 32 to 48 and Comparative Examples 8 to 16

The recordable optical recording media having a layer construction shown in FIG. 1 or 2 were prepared in order to evaluate recording or regenerating signals of the inventive recordable optical recording media.

### Medium of FIG. 1

On a polycarbonate substrate 1 (by Mitsubishi Engineering-Plastics Co., Yupilon H-4000) of 0.6 mm thick, which being injection-molded by use of the molding machine and the metal mold of Example 1, a lower protective layer 2 of Al₂O₃ of 15 nm thick, a recording layer 3 of Bi₁₀Fe₅Oₓ of 13 nm thick, a upper protective layer 4 of ZnS—SiO₂ (80:20% by mole) of 20 nm thick, and a reflective layer 5 of AlTi (Ti: 1% by mass) of 110 nm thick were laminated in order using a sputtering apparatus (DVD splinter, by Elicon Co.).

Then a UV curable resin (by Dainippon Ink & Chemicals, Inc., SD-381) was coated on the reflective layer 5 by a spin coating process thereby to form an overcoat layer 6 of 5 μm thick. In addition, a protective polycarbonate substrate 8 of 0.6 mm thick was laminated on the overcoat layer 6 using a UV curable resin (by Nippon Kayaku Co., KAYARAD DVD-003) as the adhesive layer 7.

### Medium of FIG. 2

On a polycarbonate substrate 1 (by Mitsubishi Engineering-Plastics Co., Yupilon H-4000) of 1.1 mm thick, which being injection-molded by use of the molding machine and the metal mold of Example 1, a reflective layer 5 of AlTi (Ti: 1% by mass) of 35 nm thick, an upper protective layer 4 of Si₃N₄ of 13 nm thick, a recording layer 3 of Bi₂BOₓ of 16 nm thick, and a lower protective layer 2 of ZnS—SiO₂ (80: 20% by mole) of 10 nm thick were laminated in order by a sputtering process.

Then a UV curable resin (by Nippon Kayaku Co., KAYARAD BRD-807) was coated on the lower protective layer 2 by a spin coating process thereby to form a cover layer 9 of 0.1 mm thick.

In the formulas of materials of the recording layers, the subscript “x” means an oxygen deficiency. These recording layers are typically formed by a sputtering process using a target of constitutional elements (Bi, Fe, B) of oxides having a stoichiometric composition, and usually causing an oxygen deficiency. The degree of oxygen deficiency is difficult to accurately determine, thus is expressed by “x” instead. As a result of the oxygen deficiency, there exists elemental Bi, Fe or B in the recording layer.

All of the recordable optical recording media, prepared as described above, had a recording polarity of “high to low”.

As for the evaluation of recording and reproducing properties of these optical recording media, the optical recording media of FIG. 1 were formed recording marks on their tracks by use of an optical disc evaluation device ODU-1000 (by Pulsetec Industrial Co., wavelength 405 nm, NA 0.65) in accordance with HD DVD-R specification (DVD Specifications for High Density Recordable Disc (HD DVD-R) Version1.1); the optical recording media of FIG. 2 were formed recording marks on their tracks by use of an optical disc evaluation device ODU-1000 (by Pulsetec Industrial Co., wavelength 405 nm, NA 0.85) in accordance with Blu-ray Disc Recordable (BD-R) specification (System Description Blu-ray Disc Recordable Format Version1.0); and the recording-regenerating signals were evaluated under one times of specification velocity.

The recording strategy shown in FIGS. 3, 4 was employed in the recording process such that the recording layer was preheated by applying a preheating pulse of preheating power Pb then the recording power Pw was applied. In the case of FIG. 4, a cooling power Pc was further applied, thereby, the recording layer was preheated previously below the temperature at which recording marks stating to form, then the preheated recording layer was heated above the temperature at which recording marks stating to form. In the case of FIG. 4, the cooling of the recording layer was prompted by applying a cooling power.

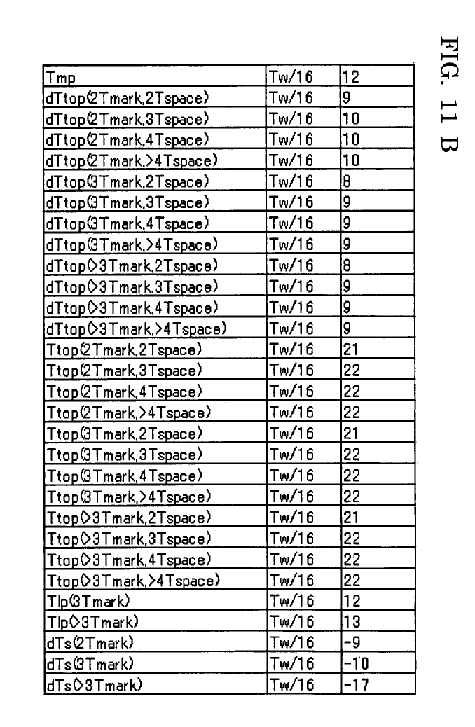

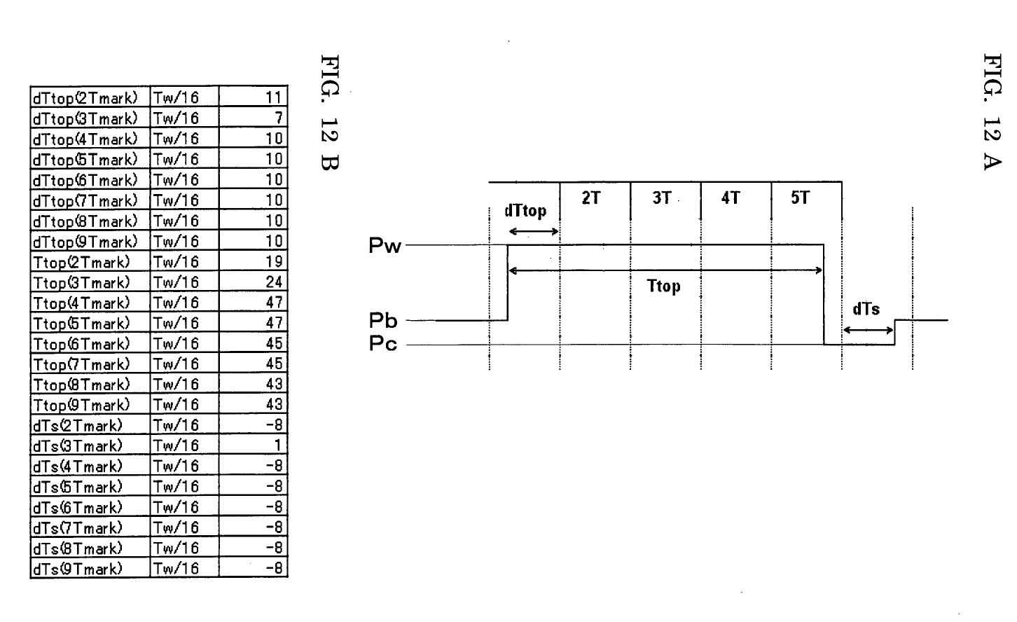

The wave profile and parameters as regards recording strategy of the optical recording medium of FIG. 1 are shown in FIGS. 10 A and B, the wave profile and parameters as regards recording strategy of the optical recording medium of FIG. 2 are shown in FIGS. 11A and B, and the strength of each power (mW), and ratio of preheating power and recording power (Pb/Pw) are shown in Table 7 (T in the figures represent a cycle of channel clock). When no cooling power Pc is applied, the wave profile has no cooling pulse at the right end in FIGS. 10 A and 11 A. Regenerating power Pr is indicated in Table 7, but is omitted in FIGS. 10 A, 11 A since FIGS. 10 A, 11 A show a wave profile of recording strategy. The marks as regards parameters in FIGS. 10 B and 11 B are also used in the specification.

The index of recording quality in evaluation of the recording and regenerating signals was PRSNR on the basis of HD DVD-R specification, with respect to optical recording media of FIG. 1. The evaluation criteria are as follows:
A: 15≦PRSNR
B: PRSNR <15

On the other hand, the index was jitter on the basis of Blue-ray Disk Recordable specification, with respect to optical recording media of FIG. 2. The evaluation criteria are as follows:
A: jitter >6.5%
B: 6.5%<jitter

The evaluation results are shown in Table 7.

TABLE 7
Configuration of FIG. 1

| | Pw (mW) | Pr (mW) | Pb (mW) | Pb/Pw (%) | Pc (mW) | PRSNR (—) | Evaluation |
|---|---|---|---|---|---|---|---|
| Ex. 32 | 8.8 | 0.4 | 1.5 | 17.0 | non | 18 | A |
| Ex. 33 | 8.8 | 0.4 | 3.5 | 39.8 | non | 28 | A |
| Ex. 34 | 8.8 | 0.4 | 5.5 | 62.5 | non | 17 | A |
| Ex. 35 | 8.8 | 0.4 | 1.5 | 17.0 | 0.4 | 20 | A |
| Ex. 36 | 8.8 | 0.4 | 3.5 | 39.8 | 0.4 | 32 | A |
| Ex. 37 | 8.8 | 0.4 | 5.5 | 62.5 | 0.4 | 21 | A |
| Com. Ex. 8 | 8.8 | 0.4 | 0.4 | 4.5 | non | 14 | B |
| Com. Ex. 9 | 8.8 | 0.4 | 6.5 | 73.9 | non | 10 | B |
| Com. Ex. 10 | 8.8 | 0.4 | 0.4 | 4.5 | 0.4 | 14 | B |
| Com. Ex. 11 | 8.8 | 0.4 | 6.5 | 73.9 | 0.4 | 13 | B |

Configuration of FIG. 2

| | Pw (mW) | Pr (mW) | Pb (mW) | Pb/Pw (%) | Pc (mW) | jitter | Evaluation |
|---|---|---|---|---|---|---|---|
| Ex. 38 | 4.5 | 0.35 | 1 | 22.2 | non | 6.3 | A |
| Ex. 39 | 4.5 | 0.35 | 2 | 44.4 | non | 5.9 | A |
| Ex. 40 | 4.5 | 0.35 | 2.5 | 55.6 | non | 6.4 | A |
| Ex. 41 | 4.5 | 0.35 | 1 | 22.2 | 0.1 | 6.0 | A |
| Ex. 42 | 4.5 | 0.35 | 2 | 44.4 | 0.1 | 5.3 | A |
| Ex. 43 | 4.5 | 0.35 | 2.5 | 55.6 | 0.1 | 5.5 | A |
| Ex. 44 | 4.5 | 0.35 | 0.7 | 15.6 | non | 6.4 | A |
| Ex. 45 | 4.5 | 0.35 | 0.5 | 11.1 | non | 6.5 | A |
| Ex. 46 | 4.5 | 0.35 | 3 | 66.7 | non | 6.5 | A |
| Ex. 47 | 4.5 | 0.35 | 3.15 | 70.0 | non | 6.5 | A |
| Ex. 48 | 4.5 | 0.35 | 1 | 22.2 | 0.8 | 6.5 | A |
| Com. Ex. 12 | 4.5 | 0.35 | 0.35 | 7.8 | non | 7.0 | B |
| Com. Ex. 13 | 4.5 | 0.35 | 3.2 | 71.1 | non | 7.5 | B |
| Com. Ex. 14 | 4.5 | 0.35 | 0.35 | 7.8 | 0.1 | 6.7 | B |
| Com. Ex. 15 | 4.5 | 0.35 | 3.2 | 71.1 | 0.1 | 6.8 | B |
| Com. Ex. 16 | 4.5 | 0.35 | 1 | 22.2 | 1 | 6.7 | B |

The results of Examples 32 to 48 in Table 7 demonstrate that the preheating power of no more than 70% of the recording power leads to PRSNR of no less than 15 or jitter of no more than 6.5%.

In contrast, the preheating power of above 70% of the recording power, as Comparative Examples 9, 11, 13 and 15 leads to insufficient recording quality such as PRSNR of less than 15 or jitter of more than 6.5%. The reason of inferior recording quality is believed that excessively intense preheating power brings about spreading the recording marks.

In comparative examples 8, 10, 12 and 14, the recording quality is inferior since the preheating power and the regenerating power are substantially the same. It is believed that when the preheating power is weak, the temperature rise is delayed even if the recording power is intense, thus the shape of recording marks causes fluctuation.

When a cooling step is provided, the cooling power should be lower than the preheating power; when the condition is unsatisfactory, the recording quality is inferior as Comparative Example 16.

### Examples 49 to 51

Recording and regenerating signals were evaluated with respect to optical recording media of FIG. 2, in the same way as Example 41, except that the preheating power was divided into Pb1 and Pb2, and the intensity (mW) of each power was set to the values shown in Table 8. The wave profile and parameters of the recording strategy were the same as those of FIGS. 11A and B. The results are shown in Table 8. Examples 52 to 54 and Comparative Example 17

Recording and regenerating signals were evaluated with respect to optical recording media of FIG. 2, in the same way as Example 41, except that the wave profile (monopulse of recording pulse) and parameters of the recording strategy shown in FIGS. 12 A and B were selected, the intensity (mW) of each power was set to the values shown in Table 8, and the linear velocity of recording was set to be 4 times of specification (T in the figures represent a cycle of channel clock). Regenerating power Pr is indicated in Table 8, but is omitted in FIG. 12 A since FIG. 12 A shows a wave profile of recording strategy. The marks as regards of parameters in FIG. 12 B are used in the specification without exception.

The results are shown in Table 8; the recording quality is inferior in Comparative Example 17 since the preheating power is above 70% of the recording power.

### Examples 55 to 56 and Comparative Example 18

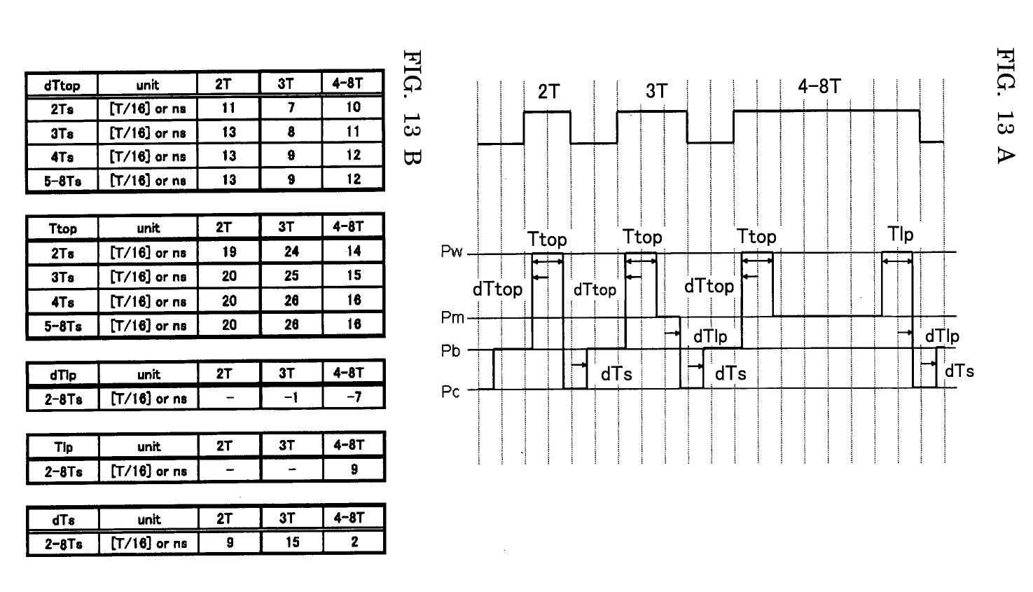

Recording and regenerating signals were evaluated with respect to optical recording media of FIG. 2, in the same way as Example 41, except that the wave profile and parameters of the recording strategy shown in FIGS. 13 A and B were selected, the intensity (mW) of each power was set to the values shown in Table 8, and the linear velocity of recording was set to be 4 times of specification (T in the figures represent a cycle of channel clock). Regenerating power Pr is indicated in Table 8, but is omitted in FIG. 13 A since FIG. 13 A shows a wave profile of recording strategy. The marks as regards of parameters in FIG. 13 B are used in the specification without exception. Pm in FIG. 13 A corresponds to the second recording power in this strategy, but there exist the second and the third recording power in FIGS. 8 and 9, thus Pm is referred to as the forth recording power.

The results are shown in Table 8; the recording quality is inferior in Comparative Example 18 since the preheating power is above 70% of the recording power.

TABLE 8
Configuration of FIG. 2

| | | | | | Pb1/ | Pb2/ | | | |
|---|---|---|---|---|---|---|---|---|---|
| | Pw | Pr | Pb1 | Pb2 | Pw | Pw | Pc | jitter | |
| | (mW) | (mW) | (mW) | (mW) | (%) | (%) | (mW) | (%) | Evaluation |
| Ex. | 4.5 | 0.35 | 1 | 1.5 | 22.2 | 33.3 | non | 6 | A |
| 49 | | | | | | | | | |
| Ex. | 4.5 | 0.35 | 1 | 2 | 22.2 | 44.4 | non | 5.5 | A |
| 50 | | | | | | | | | |
| Ex. | 4.5 | 0.35 | 1 | 3 | 22.2 | 66.7 | non | 6.3 | A |
| 51 | | | | | | | | | |

| | Pw | Pr | Pb | Pb/Pw | Pc | jitter | |
|---|---|---|---|---|---|---|---|
| | (mW) | (mW) | (mW) | (%) | (mW) | (%) | Evaluation |
| Ex. 52 | 10 | 0.35 | 2 | 20.0 | 0.1 | 6.4 | A |
| Ex. 53 | 10 | 0.35 | 4 | 40.0 | 0.1 | 6.2 | A |
| Ex. 54 | 10 | 0.35 | 6 | 70.0 | 0.1 | 6.5 | A |
| Com. Ex. 17 | 10 | 0.35 | 6.5 | 71.0 | 0.1 | 6.7 | B |

| | Pw | Pm | Pr | Pb | Pb/Pw | Pc | jitter | |
|---|---|---|---|---|---|---|---|---|
| | (mW) | (mW) | (mW) | (mW) | (%) | (mW) | (%) | Evaluation |
| Ex. 55 | 10.5 | 6.6 | 0.35 | 1.5 | 14.3 | 0.1 | 6.4 | A |
| Ex. 56 | 10.5 | 6.6 | 0.35 | 3 | 28.6 | 0.1 | 6.1 | A |
| Com. | 10.5 | 6.6 | 0.35 | 7.4 | 70.5 | 0.1 | 8 | B |
| Ex. 18 | | | | | | | | |

1. A recordable optical recording medium, comprising:
a substrate,
a recording layer, and
a reflective layer,
wherein the recording layer and the reflective layer are formed on the substrate,
the recording layer is formed of an inorganic material, and
information is recorded on the recordable optical recording medium by use of an irreversible change at the recording layer caused by irradiating blue laser light.

2. The recordable optical recording medium according to claim 1, wherein the blue laser light has a wavelength of 390 nm to 420 nm.

3. The recordable optical recording medium according to claim 1, wherein the substrate has a guide groove, and at least the recording layer, an upper protective layer, and the reflective layer are sequentially disposed on the substrate.

4. The recordable optical recording medium according to claim 1, wherein the substrate has a guide groove, and at least a lower protective layer, the recording layer, an upper protective layer, and the reflective layer are sequentially disposed on the substrate.

5. The recordable optical recording medium according to claim 1, wherein the substrate has a guide groove, and at least the reflective layer, an upper protective layer, the recording layer, and a cover layer are sequentially disposed on the substrate.

6. The recordable optical recording medium according to claim 1, wherein the substrate has a guide groove, and at least the reflective layer, an upper protective layer, the recording layer, a lower protective layer, and a cover layer are sequentially disposed on the substrate.

7. The recordable optical recording medium according to claim 4, wherein the lower protective layer is formed of an inorganic material mainly containing oxides, nitrides, carbides, sulfides, borides, silicides, elemental carbon, or mixtures thereof, and the layer thickness is 20 nm to 90 nm.

8. The recordable optical recording medium according to claim 3, wherein at least one of the lower protective layer and the upper protective layer is formed of a material mainly containing ZnS—SiO₂.

9. The recordable optical recording medium according to claim 1, wherein the substrate has a wobbled guide groove having a groove width of 170 nm to 230 nm as the full width at half maximum and a groove depth of 23 nm to 33 nm.

10. The recordable optical recording medium according to claim 9, wherein a track pitch of the wobbled guide groove is within a range of 0.4±0.02 μm.

11. The recordable optical recording medium according to claim 9, wherein an amplitude of the wobble is within a range of 16±2 nm.

12. The recordable optical recording medium according to claim 1, wherein the recording layer comprises, among elements other than oxygen, bismuth as a main ingredient and further comprises bismuth oxide, and the reflective layer comprises at least one element selected from the element group (I), in an amount of 0.6 atomic % to 7.0 atomic % based on Al;
element group (I): Mg, Pd, Pt, Au, Zn, Ga, In, Sn, Sb, Be, Ru, Rh, Os, Ir, Cu, Ge, Y, La, Ce, Nd, Sm, Gd, Tb, Dy, Ti, Zr, Hf, Si, Fe, Mn, Cr, V, Ni, Bi and Ag.

13. The recordable optical recording medium according to claim 12, wherein an amount of the at least one element selected from the element group (I) is 1.0 atomic % to 5.0 atomic %.

14. The recordable optical recording medium according to claim 1, wherein the recording layer comprises bismuth, oxygen, and at least one element X selected from the element group (II);
element group (II): B, Si, P, Fe, Co, Ni, Cu, Ga, Ge, As, Se, Mo, Tc, Ru, Rh, Pd, Ag, Sn, Sb, Te, W, Re, Os, Ir, Pt, Au, Hg, Tl, Pb, Po, At, Zn, Cd and In.

15. A recording method of recording on the recordable optical recording medium according to claim 1,
wherein a recording mark is formed in accordance with a recording strategy that comprises a preheating step and subsequently a heating step,
a preheating pulse of preheating power (Pb), which is higher than reproducing power (Pr) and no higher than 70% of recording power (Pw), is irradiated in the preheating step, and
a recording pulse of the recording power (Pw) is irradiated in the heating step.

16. A method of recording on the recordable optical recording medium according to claim 1,
wherein a recording mark is formed in accordance with a recording strategy that comprises a preheating step and subsequently a heating step and a cooling step,
a preheating pulse of preheating power (Pb), which is higher than reproducing power (Pr) and no higher than 70% of recording power (Pw), is irradiated in the preheating step,
a recording pulse of the recording power (Pw) is irradiated in the heating step, and
a cooling pulse of cooling power (Pc), which being lower than the preheating power (Pb), is irradiated in the cooling step.

17. The method according to claim 15, wherein the preheating pulse comprises two or more pulses having different powers.

18. The method according to claim 15, wherein the recording pulse is a monopulse.

19. The method according to claim 18, wherein the recording power of the monopulse is changed into two or more different levels of the recording power depending on the length of a recording mark to be formed.

20. The method according to claim 15, wherein the recording pulse is a combination of two or more different powers.

21-22. (canceled)
